(19) United States
(12) Patent Application Publication
(10) Pub. No.: US 2024/0190040 A1
(43) Pub. Date: Jun. 13, 2024

(54) SLURRY FEEDSTOCK FOR EXTRUSION-BASED 3D PRINTING OF FUNCTIONALLY GRADED ARTICLES AND CASTING METAL/CERAMIC ARTICLE UNDER LOW PRESSURE AT ROOM TEMPERATURE, METHODS, AND SYSTEM THEREFOR

(71) Applicant: SOLID LAB SDN BHD, Kuala Lumpur (MY)

(72) Inventors: Jing Yuen TEY, Selangor (MY); Wei Hong YEO, Selangor (MY); Shiau Foon TEE, Selangor (MY); Chee Yuen CHEONG, Kuala Lumpur (MY)

(73) Assignee: SOLID LAB SDN BHD, Kuala Lumpur (MY)

(21) Appl. No.: 18/287,895

(22) PCT Filed: Apr. 26, 2022
(86) PCT No.: PCT/MY2022/050030

§ 371 Date: Oct. 23, 2023

(30) Foreign Application Priority Data
Apr. 26, 2021 (MY) PI2021002275
Oct. 22, 2021 (MY) PI2021006359
Apr. 25, 2022 (MY) PI2022002158

(51) Int. Cl. B28B 1/00; B22F 10/20; B28B 1/14; B33Y 10/00; B33Y 30/00; B33Y 70/10; C04B 35/626; C04B 35/636

(52) U.S. Cl. CPC B28B 1/001; B22F 10/20; B28B 1/14; C04B 35/62625; C04B 35/6365; B33Y 10/00; B33Y 30/00; B33Y 70/10; C04B 2235/48

(57) ABSTRACT

The present invention discloses a slurry feedstock for extrusion-based three-dimensional, 3D, printing of a functionally graded article, and/or for casting an article under a low pressure at a room temperature, a method of preparing the same, a method of extrusion-based 3D printing and/or casting, and a system therefor. The slurry feedstock comprises a build material comprising a metal, a ceramic or any combinations thereof, an organic polymer binder, an additive and a volatile organic solvent. The build material mixed with the additive and the organic polymer binder dissolved with the volatile organic solvent form a first pre-mix and a second pre-mix, respectively, that are mixed to form a substantially homogeneous and flowable slurry mixture that is used for producing articles.

### FIELD OF THE INVENTION

The present invention generally relates to the field of additive manufacturing and/or mould casting. More particularly, the present invention relates to a slurry feedstock for extrusion-based three-dimensional (3D) printing of a functionally graded article and/or for casting an article under a low pressure at a room temperature, a method of preparing the same, a method of extrusion-based 3D printing and/or casting, and a system thereof.

### BACKGROUND OF THE INVENTION

Additive manufacturing, also called 3D printing, is a transformative approach to industrial production that creates a three-dimensional article or part from a digital file. This technology enables the building of 3D, solid objects and thus the realization of complex parts. Typically, thin layers of material are deposited to create complex shapes which cannot be produced by conventional or traditional techniques such as casting, forging, and machining. 3D printing is seen as being one of the significant revolutionary industrial processes of the next few years. It is a highly intriguing and profitable market in the investing circle, with the limitless options it presents to companies and industries worldwide.

One major advancement of additive manufacturing is the ability to produce a functionally graded material (FGM). FGM, whose structural properties vary along their volume, has the properties of two raw materials mixed together. By comparison, traditional composites are homogeneous mixtures, and they therefore involve a compromise between the desirable properties of the component materials. Since significant proportions of an FGM contain the pure form of each component, the need for compromising such desirable properties of the component materials is abolished. The properties of both components can be used to the full. For instance, ceramic can be mixed with metal to finally form an FGM article without any compromise in the toughness of the metal side or the refractoriness of the ceramic side. Conventionally, laser powder deposition and solid-state powder forging are utilized in the fabrication of the FGMs. Other conventional fabrication methods include in situ processing techniques such as laser cladding, spray forming, sedimentation, and solidification.

Among additive manufacturing techniques, vat photopolymerization, in which ultraviolet light is deployed to form chains between molecules of liquid light-curable resin, crosslink them, and as a result, solidify the resin, is used to create FGM parts or articles. Laser-based processes such as selective laser sintering and selective laser melting and fused deposition modelling also can be used to deposit material, layer upon layer, in various geometric shapes (i.e., adds material to create an object). Interestingly, one common feature between these additive manufacturing techniques is the variation of the material properties that is restricted to only a single dimension space in a discrete form which usually falls on the printing direction or z-axis. These techniques are unfortunately not well aligned with that and the echoes of the FGMs. Moreover, the vat photopolymerization and FDM are primarily involved in the printing of thermoplastic or plastic composite (in the form of solid feedstock), a bigger drawback that makes them less versatile or adds a significant weakness. Another major drawback of many conventional 3D printings is that they only allow one material to be printed at a time by laying down successive layers of material, limiting many potential applications which require the integration of different materials with composition variations in the same object such as FGM articles. The use of solid feedstock of material in the conventional 3D printings also, disadvantageously, prohibits in situ mixing of the feedstock components at the time of printing articles. It is, therefore, desirous of developing a new feedstock and additive manufacturing technique capable of fabricating an FGM article with variation or gradient across more than one axis.

On the other hand, casting basically is accomplished by pouring a liquid material, usually molten metal, into a mould cavity that takes the form of the desired part. The liquid material then cools, with heat generally being extracted via the mould until it solidifies into the desired shape. As simple as it may sound, casting is generally quite a complex process due to the complex metallurgy of using molten metal. Casting processes may be divided into an expendable mould process and a permanent mould process. With the expendable mould process, the mould (typically made from sand, plaster and ceramics) is destroyed in order to remove the casting. However, with the permanent mould process, the mould (typically made from metals that retain their strength at elevated temperature) is reused and must therefore be designed to allow for easy removal of the casting.

One problem with conventional casting is that it pre-requisitely demands the melting of metal into a molten state before being allowed to flow into the mould cavity. Such melting process, disadvantageously, requires increasingly high energy at extremely high temperatures, depending on the melting points of metals used. On top of that, although the molten metal can be pulled down by gravity, in practical and reality, a considerable amount of pressure must be exerted or applied in order to push the molten metal into the mould cavity in its entirety. Other casting methods such as powder injection moulding also, unfortunately, suffer the same high-pressure demand where the mould itself must be subjected to extremely high pressure, besides high tooling costs and long set up lead times. It is, therefore, desirous of developing a new greener feedstock and mould casting technique capable of fabricating a metal/ceramic article at significantly reduced energy requirements and tooling costs.

By way of background, the United States Patent Application Publication No. 2014/0087210 A1 (hereinafter the '210 publication) discloses a method of making a metallic or ceramic component, such as a cutting or forming tool, from at least two distinct powder precursors. In the '210 publication, the method comprises forming a first mixture comprised of a plurality of coated particles, such as tough-coated hard powder (TCHP) composite particles created by encapsulating extremely hard core particles with very tough binder and structural materials, and at least one support powder, such as a carbide, typically WC—Co. The mixture, according to the '210 publication, is formed into a green body and sintered to form a functionally graded or multi-component article. The International PCT Patent Application Publication No. WO 2018/009593 A1 (hereinafter the '593 publication) discloses methods of making metal objects. These methods, according to the '593 publication, generally involve adding a metal powder slurry into a sacrificial mould, such as a mould made by three-dimensional printing, and heating the slurry/mould mixture. In the '593 publication, the heating steps may include curing the slurry to make a green part inside the mould, debinding to burn off the mould and binder to make a brown part, sintering, and hot isostatic pressing.

For the reasons stated above and for other reasons which will become apparent to those skilled in the art upon reading and understanding the specification, there is a need in the art for an improved feedstock for use in fabricating an FGM article having variations of different materials across or over the volume in one or more directions, where a gradual change may be realized as a linear or continuous change in properties and/or discrete changes between two or more distinct, more or less well-defined layers that have some property in common to make them mutually compatible, an additive manufacturing technique thereof, an improved feedstock for use in casting a metal/ceramic article under a low pressure at a room temperature, a mould casting technique and a system thereof. Although there may be similar feedstocks and manufacturing techniques for the same in the prior art, for many practical purposes, there is still considerable room for improvement.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

Accordingly, the present invention provides a slurry feedstock for extrusion-based three-dimensional (3D) printing of a functionally graded article.

The slurry feedstock of the present invention may be characterised by a build material comprising a metal, a ceramic or any combinations thereof, wherein the build material is porous, non-porous or any combinations thereof, wherein the build material is in an amount from 10 vol. % to 90 vol. %; an organic polymer binder selected from a group comprising a cellulose ester, a cellulose ether, and derivatives thereof, wherein the organic polymer binder is in a concentration from 150 g/L to 550 g/L; an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and a volatile organic solvent, wherein the build material mixed with the additive and the organic polymer binder dissolved with the volatile organic solvent form a first pre-mix and a second pre-mix, respectively, that are mixed to form a substantially homogeneous and flowable slurry mixture that is printed as a preliminary part of the said functionally graded article, wherein the organic polymer binder is debound from the preliminary part in either or both a thermal decomposition treatment and a solvent debinding treatment followed by sintering to thereby produce a final part of the functionally graded article containing the build material having selectively varied in composition, structure including infill pattern or any combinations thereof gradually over volume of the final part thereof in one or more directions.

Preferably, the metal is selected from a group comprising a ferrous metal, a non-ferrous metal, a ferrous metal alloy, and a non-ferrous metal alloy.

Preferably, the ceramic is selected from a group comprising a silicate ceramic including clay, cordierite ceramics, steatite, stoneware, earthenware, porcelain, kaolin, quartz, silica, chamotte, bentonite, mullite, an oxide ceramic including alumina, zirconia including zirconia stabilized in yttria (Y₃O₂), beryllium oxide, yttrium oxide, titanium oxide, magnesium oxide, calcium oxide, barium oxide, zinc oxide, uranium oxide (UO₂), plutonium dioxide (PuO₂), yttrium barium copper oxide, spinel, magnetoplumbite, perovskite, tialite, a non-oxide ceramic including carbide ceramic including titanium carbide, boron carbide, tungsten carbide, silicon carbide, nitride ceramics including silicon nitride, boron nitride, aluminium nitride, aluminium oxynitride, SiAlON, a bioceramic including calcium phosphate ceramic including hydroxyapatite (HAP), tricalcium phosphate (TCP), amorphous calcium phosphate (ACP), octacalcium phosphate (OCP), dicalcium phosphate anhydrous (DCPA), dicalcium phosphate dihydrate (DCPD), tetracalcium phosphate monoxide (TetCp), biphasic calcium phosphate (BCP) and any combinations thereof.

Preferably, the build material comprises a particle mesh size of not more than 300 μm.

Preferably, the cellulose ester is selected from a group comprising a cellulose acetate, a cellulose acetate phthalate, a cellulose diacetate, a cellulose triacetate, a cellulose acetate butyrate, a cellulose butyrate, a cellulose tributyrate, a cellulose acetate propionate, a cellulose propionate, a cellulose tripropionate, a cellulose nitrate, a cellulose acetate propionate, a carboxymethyl cellulose acetate, a carboxymethyl cellulose acetate propionate, a carboxymethyl cellulose acetate butyrate, a cellulose acetate butyrate succinate, a cellulose propionate butyrate, and mixtures thereof.

Preferably, the cellulose ether is selected from a group comprising a methyl cellulose, an ethyl cellulose, a hydroxyethyl cellulose, a hydroxypropyl cellulose, a methylhydroxyethyl cellulose, a methylhydroxypropyl cellulose, an ethylhydroxyethyl cellulose, a methylethylhydroxyethyl cellulose, a hydrophobically modified ethylhydroxyethylcellulose, a hydrophobically modified hydroxyethylcellulose, an alkyl cellulose, a hydroxyalkyl cellulose, a carboxyalkyl cellulose, a carboxyalkyl hydroxyalkyl cellulose and mixtures thereof.

Preferably, the organic polymer binder comprises a number average molecular weight of not more than 150,000.

Preferably, the volatile organic solvent is selected from a group comprising a ketone including an acetone, a butanone, a methyl ethyl ketone, a methyl amyl ketone, a methyl isobutyl ketone and a cyclohexanone, an aliphatic hydrocarbon, an aromatic hydrocarbon, an alcohol including a methanol, an ethanol, a propanol, an isopropyl alcohol and a butanol, a methyl formate, an ethylene carbonate, a propylene carbonate, a diethyl carbonate, a dimethyl carbonate, an ethyl methyl carbonate, a propylene carbonate, a 1,2-dimethoxy ethane and a γ-butyrolactone, an ethyl acetate, an isopropyl acetate, an ethyl ether, a methyl tert-butyl ether, a tetrahydrofuran, a diozane, a nitromethane, an acetonitrile, a methyl cyclohexane, an n-heptane, an n-hexane, a cyclohexane, a dipropylene glycol n-butyl ether and mixtures thereof.

Preferably, the substantially homogeneous and flowable slurry mixture includes two or more substantially homogeneous and flowable slurry mixtures, each comprising a respective first pre-mix and a respective second pre-mix.

Preferably, the two or more substantially homogeneous and flowable slurry mixtures are instantaneously mixed in situ in a static or active mixer to form one substantially homogeneous and flowable slurry mixture.

Preferably, the second pre-mix is in an amount from 10 vol. % to 90 vol. %.

Preferably, the slurry feedstock further comprises a support material forming a substantially homogeneous and flowable support mixture configured for printing a support structure for an overhanging or cantilevered portion of the said functionally graded article.

Preferably, the said support material comprises a ceramic, a sacrificial material, a fugitive material or any combinations thereof.

Preferably, the sacrificial material is debound from the preliminary part in either or both a thermal decomposition treatment and a solvent debinding treatment.

Preferably, the fugitive material is debound from the preliminary part in either or both a thermal decomposition treatment and a solvent debinding treatment.

In accordance with a second aspect of the present invention, a method of preparing a slurry feedstock for extrusion-based 3D printing a functionally graded article is provided.

The preparation method of the present invention may be characterised by the steps of preparing a build material comprising a metal, a ceramic or any combinations thereof, including providing the build material that is porous, non-porous or any combinations thereof; and providing the build material in an amount from 10 vol. % to 90 vol. %; preparing an organic polymer binder selected from a group comprising a cellulose ester, a cellulose ether, and derivatives thereof, including providing the organic polymer binder in a concentration from 150 g/L to 550 g/L; preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; preparing a volatile organic solvent; and forming a first pre-mix by mixing the build material with the additive; forming a second pre-mix by mixing the organic polymer binder with the volatile organic solvent; mixing the first pre-mix and the second pre-mix to form a substantially homogeneous and flowable slurry mixture that is printed as a preliminary part of the said functionally graded article, wherein the organic polymer binder is debound from the preliminary part in either or both a thermal decomposition treatment and a solvent debinding treatment followed by sintering to thereby produce a final part of the functionally graded article containing the build material having selectively varied in composition, structure including infill pattern or any combinations thereof gradually over volume of the final part thereof in one or more directions.

Preferably, the method includes the step of forming two or more substantially homogeneous and flowable slurry mixtures, each comprising a respective first pre-mix and a respective second pre-mix.

Preferably, the method includes the step of instantaneously mixing the two or more substantially homogeneous and flowable slurry mixtures in situ in a static or active mixer to form one substantially homogeneous and flowable slurry mixture.

Preferably, the method includes the step of preparing a support material to form a substantially homogeneous and flowable support mixture configured for printing a support structure for an overhanging or cantilevered portion of the said functionally graded article.

In accordance with a third aspect of the present invention, a method of extrusion-based 3D printing a functionally graded article is provided.

The printing method of the present invention may be characterised by the steps of providing a slurry feedstock, including preparing a build material comprising a metal, a ceramic or any combinations thereof, including providing the build material that is porous, non-porous or any combinations thereof; and providing the build material in an amount from 10 vol. % to 90 vol. %; preparing an organic polymer binder selected from a group comprising a cellulose ester, a cellulose ether, and derivatives thereof, including providing the organic polymer binder in a concentration from 150 g/L to 550 g/L; preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and preparing a volatile organic solvent; forming a first pre-mix by mixing the build material with the additive; forming a second pre-mix by mixing the organic polymer binder with the volatile organic solvent; mixing the first pre-mix and the second pre-mix to form a substantially homogeneous and flowable slurry mixture that is printed as a preliminary part of the said functionally graded article, debinding the organic polymer binder from the preliminary part in either or both a thermal decomposition treatment and a solvent debinding treatment; and subjecting the preliminary part having the organic polymer binder debound therefrom to sintering for producing a final part of the functionally graded article containing the build material having selectively varied in composition, structure including infill pattern or any combinations thereof gradually over volume of the final part thereof in one or more directions.

Preferably, the method includes the step of forming two or more substantially homogeneous and flowable slurry mixtures, each comprising a respective first pre-mix and a respective second pre-mix.

Preferably, the method includes the step of instantaneously mixing the two or more substantially homogeneous and flowable slurry mixtures in situ in a static or active mixer to form one substantially homogeneous and flowable slurry mixture.

Preferably, the method includes the step of providing a support structure for an overhanging or cantilevered portion of the said functionally graded article, wherein the support structure comprises a substantially homogeneous and flowable support mixture formed from a support material.

In accordance with a fourth aspect of the present invention, a system for extrusion-based 3D printing a functionally graded article is provided.

The system of the present invention may be characterised by one or more receptacles configured for receiving a slurry feedstock comprising a build material comprising a metal, a ceramic or any combinations thereof, wherein the build material is porous, non-porous or any combinations thereof, wherein the build material is in an amount from 10 vol. % to 90 vol. %; an organic polymer binder selected from a group comprising a cellulose ester, a cellulose ether, and derivatives thereof, wherein the organic polymer binder is in a concentration from 150 g/L to 550 g/L; an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and a volatile organic solvent, wherein the build material mixed with the additive and the organic polymer binder dissolved with the volatile organic solvent form a first pre-mix and a second pre-mix, respectively, that are mixed to form a substantially homogeneous and flowable slurry mixture; a means for regulating injection of the slurry feedstock contained in the one or more receptacles thereof, wherein the means for regulating injection is selected from a group comprising a solenoid valve, a mechanical pump and a combination thereof; a computing unit comprising a control unit configured for generating a control signal to the said means for regulating injection, wherein the control unit is connected to a database comprising a predefined set of material and rheology profiles employed to operatively effect the control signal in respect of a final part of the said functionally graded article; a fluid drive device configured for providing a fluidic pressure to the slurry feedstock contained in the one or more receptacles thereof or to the means for regulating injection, which, in turn, actuates the slurry feedstock in the one or more receptacles connected thereof to provide a pressurized slurry feedstock, wherein the fluid drive device is selected from a group comprising a pneumatic drive device, a hydraulic drive device, a mechanical displacement device and any combinations thereof; and a print head operatively driven by the computing unit thereof configured for jetting the said substantially homogeneous and flowable slurry mixture to produce a preliminary part of the said functionally graded article, wherein the organic polymer binder is debound from the preliminary part in either or both a thermal decomposition treatment and a solvent debinding treatment followed by sintering to thereby produce the final part of the functionally graded article containing the build material having selectively varied in composition, structure including infill pattern or any combinations thereof gradually over volume of the final part thereof in one or more directions.

Preferably, the system comprises a static or active mixer configured for instantaneously mixing two or more substantially homogeneous and flowable slurry mixtures in situ to form one substantially homogeneous and flowable slurry mixture prior to transfer to the print head.

Preferably, the system comprises a static or active mixer configured for instantaneously mixing two or more substantially homogeneous and flowable slurry mixtures in situ to form one substantially homogeneous and flowable slurry mixture prior to transfer to the print head.

Preferably, the one or more receptacles receives a support material forming a substantially homogeneous and flowable support mixture that prints, through the said print head or another print head, a support structure for an overhanging or cantilevered portion of the said functionally graded article.

In accordance with a fifth aspect of the present invention, a slurry feedstock for casting an article under a low pressure at a room temperature is provided.

The said slurry feedstock of the present invention may be characterised by a build material comprising a metal, a ceramic or any combinations thereof, wherein the build material is porous, non-porous or any combinations thereof, wherein the build material is in an amount from 10 vol. % to 90 vol. %; an organic polymer binder selected from a group comprising a cellulose ester, a cellulose ether, and derivatives thereof, wherein the organic polymer binder is in a concentration from 50 g/L to 550 g/L; an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and a volatile organic solvent, wherein the build material mixed with the additive and the organic polymer binder dissolved with the volatile organic solvent form a first pre-mix and a second pre-mix, respectively, that are mixed to form a substantially homogeneous and flowable slurry mixture that is subjected to moulding in a cavity of a mould substantially immersed in a coagulation bath for producing a preliminary part of the said article by way of phase inversion, wherein the organic polymer binder is debound from the preliminary part in either or both a thermal decomposition treatment and a solvent debinding treatment followed by sintering to thereby produce a final part of the article.

In accordance with a sixth aspect of the present invention, a method of preparing a slurry feedstock for casting an article under a low pressure at a room temperature is provided.

The said method of the present invention may be characterised by the steps of preparing a build material comprising a metal, a ceramic or any combinations thereof, including providing the build material that is porous, non-porous or any combinations thereof; and providing the build material in an amount from 10 vol. % to 90 vol. %; preparing an organic polymer binder selected from a group comprising a cellulose ester, a cellulose ether, and derivatives thereof, including providing the organic polymer binder in a concentration from 50 g/L to 550 g/L; preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; preparing a volatile organic solvent; and forming a first pre-mix by mixing the build material with the additive; forming a second pre-mix by mixing the organic polymer binder with the volatile organic solvent; mixing the first pre-mix and the second pre-mix to form a substantially homogeneous and flowable slurry mixture that is subjected to moulding in a cavity of a mould substantially immersed in a coagulation bath for producing a preliminary part of the said article by way of phase inversion; wherein the organic polymer binder is debound from the preliminary part in either or both a thermal decomposition treatment and a solvent debinding treatment followed by sintering to thereby produce a final part of the article.

In accordance with a seventh aspect of the present invention, a method of casting an article under a low pressure at a room temperature.

The said method of the present invention may be characterised by the steps of providing a slurry feedstock, including preparing a build material comprising a metal, a ceramic or any combinations thereof, including providing the build material that is porous, non-porous or any combinations thereof; and providing the build material in an amount from 10 vol. % to 90 vol. %; preparing an organic polymer binder selected from a group comprising a cellulose ester, a cellulose ether, and derivatives thereof, including providing the organic polymer binder in a concentration from 50 g/L to 550 g/L; preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and preparing a volatile organic solvent; forming a first pre-mix by mixing the build material mixed with the additive; forming a second pre-mix by mixing the organic polymer binder dissolved with the volatile organic solvent; mixing the first pre-mix and the second pre-mix to form a substantially homogeneous and flowable slurry mixture; subjecting the said substantially homogeneous and flowable slurry mixture to moulding in a mould; substantially immersing the mould having a cavity filled with the substantially homogeneous and flowable slurry mixture thereof in a coagulation bath to produce a preliminary part of the said article by way of phase inversion; debinding the organic polymer binder from the preliminary part in either or both a thermal decomposition treatment and a solvent debinding treatment; and subjecting the preliminary part having the organic polymer binder debound therefrom to sintering for producing a final part of the article.

In accordance with an eighth aspect of the present invention, a system for casting an article under a low pressure at a room temperature is provided.

The said system of the present invention may be characterised by one or more receptacles configured for receiving a slurry feedstock comprising a build material comprising a metal, a ceramic or any combinations thereof, wherein the build material is porous, non-porous or any combinations thereof, wherein the build material is in an amount from 10 vol. % to 90 vol. %; an organic polymer binder selected from a group comprising a cellulose ester, a cellulose ether, and derivatives thereof, wherein the organic polymer binder is in a concentration from 50 g/L to 550 g/L; an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and a volatile organic solvent, wherein the build material mixed with the additive and the organic polymer binder dissolved with the volatile organic solvent form a first pre-mix and a second pre-mix, respectively, that are mixed to form a substantially homogeneous and flowable slurry mixture; a mould configured for moulding the said substantially homogeneous and flowable slurry mixture received from the one or more receptacles thereof; and a coagulation bath configured for substantially immersing the mould having a cavity filled with the substantially homogeneous and flowable slurry mixture therein to produce a preliminary part of the said article by way of phase inversion; and a means for debinding the organic polymer binder from the preliminary part, wherein the means for debinding comprises either or both a thermal decomposition treatment and a solvent debinding treatment followed by sintering to thereby produce a final part of the article.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

A more complete appreciation of the invention and many of the attendant advantages thereof will be readily as the same becomes better understood by reference to the following detailed description when considered in connection with the accompanying drawings, wherein:

FIG. 1 shows a setup for dual material printing according to one embodiment of the present invention;

FIG. 2 shows a setup for dual material printing, wherein Material A refers to a first substantially homogeneous and flowable slurry mixture (e.g., metal as the build material) and Material B refers to a second substantially homogeneous and flowable slurry mixture (e.g., ceramic as the build material) according to one embodiment of the present invention;

FIGS. 3a and 3b, respectively, show a side view and a top view of a functionally graded article fabricated using a slurry feedstock through extrusion-based three-dimensional (3D) printing, wherein Material A refers to a first substantially homogeneous and flowable slurry mixture (e.g., metal as the build material) and Material B refers to a second substantially homogeneous and flowable slurry mixture (e.g., ceramic as the build material) according to one embodiment of the present invention;

FIG. 4 shows a porosity gradient of a porous functionally graded article fabricated using a slurry feedstock through extrusion-based 3D printing according to one embodiment of the present invention;

FIG. 5a shows an isometric view of a functionally graded article fabricated using a slurry feedstock through extrusion-based 3D printing, wherein Material A refers to a first substantially homogeneous and flowable slurry mixture (e.g., metal as the build material) and Material B refers to a second substantially homogeneous and flowable slurry mixture (e.g., ceramic as the build material) according to one embodiment of the present invention;

FIG. 5b shows a section view of a functionally graded article of FIG. 5a along the line A-A, wherein Material A refers to a first substantially homogeneous and flowable slurry mixture (e.g., metal as the build material) and Material B refers to a second substantially homogeneous and flowable slurry mixture (e.g., ceramic as the build material) according to one embodiment of the present invention;

FIGS. 6a and 6b are photographs showing, in a cross-sectional view, a green part having a concentric shape being the functionally graded article produced using a slurry feedstock through extrusion-based 3D printing according to one embodiment of the present invention;

FIG. 6c illustrates a gradient transition in an x-y plane of a first layer of the green part of FIGS. 6a and 6b according to one embodiment of the present invention;

FIG. 6d illustrates a gradient transition in an x-y plane of a second layer of the green part of FIGS. 6a and 6b according to one embodiment of the present invention;

FIG. 7 is a flow diagram depicting a method of preparing a slurry feedstock for extrusion-based 3D printing a functionally graded article according to one embodiment of the present invention;

FIG. 8 is a flow diagram depicting a method of extrusion-based 3D printing a functionally graded article according to one embodiment of the present invention;

FIG. 9a illustrates a system setup for extrusion-based 3D printing of a functionally graded article according to one embodiment of the present invention;

FIG. 9b illustrates a mechanism for extrusion-based 3D printing of a functionally graded article according to one embodiment of the present invention;

FIGS. 10, 11, 12 and 13, respectively, show a first system, a second system, and a third system employed for extrusion-based 3D printing a functionally graded article fabricated using a slurry feedstock according to one embodiment of the present invention;

FIG. 14 illustrates an infill pattern and its density for use in a functionally graded article according to one embodiment of the present invention;

FIG. 15 illustrates a support structure printed on a platform for an overhanging or cantilevered portion of a functionally graded article according to one embodiment of the present invention;

FIG. 16 shows a first setup for printing a support structure for an overhanging or cantilevered portion of the said functionally graded article using a single print head or nozzle, wherein Material A refers to a first substantially homogeneous and flowable slurry mixture (e.g., metal as the build material), Material B refers to a second substantially homogeneous and flowable slurry mixture (e.g., ceramic as the build material) and Material C refers to a substantially homogeneous and flowable support mixture, wherein Materials A, B and C are mixed in a single static or active mixture according to one embodiment of the present invention;

FIG. 17 shows a second setup for printing a support structure for an overhanging or cantilevered portion of the said functionally graded article using two print heads or nozzles, wherein Material A refers to a first substantially homogeneous and flowable slurry mixture (e.g., metal as the build material), Material B refers to a second substantially homogeneous and flowable slurry mixture (e.g., ceramic as the build material) and Material C refers to a substantially homogeneous and flowable support mixture, wherein Materials A and B are mixed in a single static or active mixture and Material C is directed to another print head according to one embodiment of the present invention;

FIG. 18 shows a system employed for extrusion-based 3D printing a functionally graded article fabricated using a slurry feedstock that requires a support structure for its overhanging or cantilevered portion according to one embodiment of the present invention;

FIG. 19 shows a reusable mould comprising a first part having a cavity recessed or formed therein and a second part removably enveloping the said first part, wherein the cavity receives a single substantially homogeneous and flowable mixture, according to one embodiment of the present invention;

FIG. 20 shows the cavity of the mould of FIG. 1 that is adapted to receive two substantially homogeneous and flowable mixtures according to one embodiment of the present invention;

FIG. 21 shows the cavity of the mould of FIG. 1 that is adapted to receive two substantially homogeneous and flowable mixtures using a static or active mixer according to one embodiment of the present invention;

FIG. 22 is a flow diagram depicting a method of preparing a slurry feedstock for casting an article under a low pressure at a room temperature according to one embodiment of the present invention;

FIG. 23 is a flow diagram depicting a method of casting an article under a low pressure at a room temperature according to one embodiment of the present invention;

FIG. 24 is a block diagram illustrating the method of casting an article under a low pressure at a room temperature (elucidated in FIG. 5) according to one embodiment of the present invention;

FIG. 25 shows a diagram of a direct printing system according to one embodiment of the present invention;

FIG. 26 shows a diagram of a multi-material printer setup according to one embodiment of the present invention;

FIG. 27 shows a diagram of an in-situ mixing printer setup according to one embodiment of the present invention;

FIG. 28 shows a flow chart of a process involving 3D printed article according to one embodiment of the present invention;

FIG. 29 shows a diagram of a thermal debinding and sintering profile according to one embodiment of the present invention;

FIG. 30 shows a side view of a stainless steel-based feedstock printing according to one embodiment of the present invention;

FIG. 31 shows a perspective view of a cured article based on stainless steel according to one embodiment of the present invention;

FIG. 32 shows a perspective view of a sintered article based on stainless steel according to one embodiment of the present invention;

FIG. 33 shows a side view of a ceramic-based feedstock printing according to one embodiment of the present invention;

FIG. 34 shows a perspective view of a cured article based on ceramic according to one embodiment of the present invention; and

FIG. 35 shows a perspective view of a sintered article based on ceramic according to one embodiment of the present invention.

It is noted that the drawings may not be to scale. The drawings are intended to depict only typical aspects of the invention, and therefore should not be considered as limiting the scope of the invention.

### DETAILED DESCRIPTION OF THE INVENTION

The present invention discloses a slurry feedstock for use in extrusion-based three-dimensional (3D) printing of a functionally graded article, which is a functionally graded material (FGM), a method of preparing the same, a method of extrusion-based 3D printing the said article, and a system therefor. Advantageously, the present invention, by virtue of the said slurry feedstock through the said extrusion-based 3D printing, produces an FGM article comprising materials having varied in composition, structure including infill pattern or any combinations thereof across or over its volume in one or more directions, including those in a three-dimensional manner (of three axes). Such the FGM article produced by the present invention surprisingly demonstrates a gradual change in the volume thereof as a linear or continuous change in properties, i.e., composition, structure, infill pattern or any combinations thereof, and/or discrete changes between two or more distinct, more or less well-defined layers that have some property in common to make them mutually compatible. Further, the present invention can be used and maintained in a highly specific and compact, cost-effective, quick, and simple manner, without the use of complicated and sophisticated steps, components, or parts (e.g., feedstock heaters, etc.).

Essentially, the functionally graded article, or else known as the FGM article, of the present invention relates to a heterogeneous object characterised by its gradually varying multiple phase properties (i.e., microstructure and mechanical properties such as tensile strength, thermal conductivity, young modulus, etc.). Traditionally, FGM manufacturing techniques can be categorized according to thin and bulk FGMs. For the former, the thin FGM is typically formed through surface coatings or vapour deposition techniques. In the latter, the manufacturing techniques for the bulk FGM include powder metallurgy, centrifugal method, and additive manufacturing. In additive manufacturing, the bulk FGM can be formed through a vat photopolymerization process, a laser-based process, e.g., selective laser sintering (SLS) and selective laser melting (SLM), or a fused deposition modeling method (FDM). However, all these conventional methods could only vary the material properties in a single dimension space, which usually falls on the printing direction or the z-axis. In comparison, the FDM and the vat photopolymerization are mostly, if not all, used for thermoplastic or plastic composite printing only. These conventional methods are not capable of printing an FGM article having variation of the composition, structure, infill pattern and/or properties across a plane surface of a three-dimensional (3D) space (where the Cartesian coordinate system is based on three mutually perpendicular coordinate axes, namely x-axis, y-axis, and z-axis) or variation of at least one type of build materials, for instance, metal or ceramic.

The term “slurry” as used herein refers to solid-fluid mixtures, including both solid-liquid and solid-gas mixtures. For convenience, the present invention will be discussed in terms of a solid-liquid slurry, a feedstock composition in which solids and liquid are present in separate phases. The solid-liquid slurry is input into the system of the present invention and also includes fully or partially separated solids and liquids.

The term “feedstock” as used herein is defined as a raw material or mixture of raw materials having suitable properties for being supplied to the system of the present invention from which the functionally graded article or FGM article can be made and shall also be interpreted as being ingredients that are yet to be mixed or further mixed in order to produce a suitable mixture for injecting into the system thereof.

The term “pre-mix” as used herein refers to components that are mixed together and form one part of a blend that makes up the slurry mixture.

The term “infill pattern” or “structural infill” as used herein refers to a pattern that leaves void space within an interior and/or exterior of a functionally graded article. The pattern is preferably not visible. The said pattern includes, but not limited to, a line, a zig zag structure, a grid structure, a triangle structure, a tri-hexagonal structure, a honeycomb structure, a 3D honeycomb structure, a cubic structure, a cubic subdivision structure, an octet structure, a gyroid structure, a star structure, an octagram spiral structure, an Archimedean chord structure, a Hilbert curve structure, a rectilinear structure, a concentric structure, or any combinations thereof. The infill pattern preferably employs an adaptive infill printing process.

The term “three-dimensional printing” or “3D printing” as used herein refers to a process of printing via extrusion through a print nozzle (i.e., extrusion-based 3D printing) or otherwise providing a three-dimensional part or object that extends in three directions (for example, length, width and height) on a flat surface, plate or substrate.

The term “preliminary part” or “green part” as used herein refers to an article or preform of the functionally graded article, in its pre-sintered state, which is produced by the present invention to be further processed with other manufacturing technique(s).

The term “brown part” as used herein refers to an article of the functionally graded article produced from the preliminary or green part that has been subjected to thermal decomposition and/or solvent debinding to remove any binders, sacrificial materials and/or fugitive materials that previously held the feedstock together. The brown part may be further heated to fully sinter the part, or subjected to sintering, to produce a final or finished part of the functionally graded article.

The term “varied” or “variation” as used herein is a broad term and is used in its ordinary sense, including, but not limited to, a divergence or amount of change from a point, line, or set of data. In one embodiment, composition and/or structure of a build material in a final part of a functionally graded article can have a variation including a range of values outside of a reference or data set that represent a range of possibilities based on known or typical 3D printed article, for example. The term may encompass a positive variation, a negative variation and a neutral variation. The positive variation may indicate a positive deviation that exceeds the said reference or data set. The negative variation may indicate a negative deviation that fails to achieve the said reference or data set. The neutral variation may refer to a zero variation of composition and/or structure of the build material in respect of a reference or data set, e.g., no transition gradient.

In accordance with one preferred embodiment of the present invention, the slurry feedstock comprises a build material, an organic polymer binder, an additive (which can be optional) and a volatile organic solvent. In this regard, the organic polymer binder is dissolved in the volatile organic solvent and hence, producing an organic polymer binder solution. The additive is added to the build material to obtain predefined rheology behaviour and printing characteristic. The slurry feedstock essentially can be formed by way of blending the said organic polymer binder solution with the said build material mixed with the additive. The resulting slurry feedstock can be printed and dried at room temperature without any external heat providing means.

The build material of the present invention preferably refers to a powder that is used to form the slurry feedstock and from which the functionally graded article is built in the system for extrusion-based 3D printing of the present invention. The powder, or referred to as particulate material or particles, has a varying mesh size. In an embodiment, the build material has a particle size of not more than about 300 μm, preferably less than about 200 μm. The build material is preferably a layer forming material for use in the system for extrusion-based 3D printing of the present invention. The build material also may include ones in a variety of shapes such as granular powder, fibrous powder, and scale-like powder. In a preferred embodiment, the build material is employed in an amount from about 10 vol. % to about 90 vol. %, more preferably from about 30 vol. % to about 90 vol. %.

The build material preferably comprises a metal, a ceramic, or any combination thereof. In an embodiment of the present invention, the build material can be porous, non-porous, or any combination thereof. For instance, porous metal means metal particles having significant porosity, e.g., a porosity of more than about 0.5 cc/g. The build material may have pores smaller than 100 μm (microporous) and/or greater than 100 μm (mesoporous). The non-porous metal, on the other hand, implies metal particles having little or no porosity, e.g., a porosity of less than about 0.05 cc/g. The porous ceramic preferably has a porosity with controllable pore size and good mechanical properties. The term “porosity” as used herein refers to a volume fraction of void space in a porous article, such as the porous build material thereof.

The porous metal and/or the porous ceramic employed in the present invention, preferably the microporous ones, can be made by way of, for instance, direct foaming using a suitable foaming agent, sacrificial material, fugitive material, scaffolding material and the like. The porosity also can be controlled by the size of the crystallization of salts.

In one preferred embodiment of the present invention, the build material may comprise only the metal (porous and/or non-porous) or the ceramic (porous and/or non-porous). Also, the build material may include a combination of the metal and the ceramic at a predefined mix ratio or volume percentage suitably to meet the desired properties of the build material in relation to the functionally graded article thereof. The combination thereof, for instance, includes those of the metal and the ceramic, the porous metal and the ceramic, the metal and the porous ceramic, the porous metal, the non-porous metal and the ceramic, the metal, the porous ceramic and the non-porous ceramic, the porous metal, the non-porous metal, the porous ceramic and the non-porous ceramic and so forth. Various other combinations (e.g., a first metal, a second metal, a first ceramic, a second ceramic, etc.) are possible.

The metal employed in the present invention is preferably selected from a group comprising a ferrous metal, a non-ferrous metal, a ferrous metal alloy, and a non-ferrous metal alloy.

The ferrous metal is selected from steel, stainless steel, mild steel, cast iron, malleable iron, ductile cast iron and the like. The ferrous metal preferably includes iron, iron-chromium alloys, iron-chromium-nickel alloys, iron-chromium-zinc alloys, iron-chromium-aluminium alloys, iron-chromium-magnesium alloys, iron-chromium-lead alloys, iron-aluminium alloys, iron-zinc alloys, stainless steels, iron-nickel alloys, and combinations thereof. Preferred examples of steel and/or stainless steel include AISI 304, AISI 304L, AISI 316, AISI 316L, AISI430, AISI 630 (17-4 PH) and AISI 631 (17-7 PH). Other steels like A2 to A5, D2, H13, M2, and 4140 also may be used in the present invention.

The non-ferrous metal is selected from aluminium, aluminium alloys, magnesium, magnesium alloys, zinc, zinc alloys, cadmium, chromium (III), copper, copper (II) cadmium, lead, cobalt, cobalt-chromium, cobalt-chromium-molybdenum, nickel, nickel alloys, molybdenum, titanium, tantalum, niobium, silver and gold. Preferred examples of aluminium and/or aluminium alloys include AlSi10Mg, AlSi7Mg, ADC12 and AlMg5Mn. Preferred examples of nickel alloys include Alloy 706, Alloy 718, Alloy 625, Alloy 725, Invar types such as FeNi36 or 64FeNi, Hastelloy X, Hastelloy C and Kovar.

The ceramic employed in the present invention is preferably selected from a group comprising a silicate ceramic, an oxide ceramic, a non-oxide ceramic, a bioceramic and any combinations thereof.

The silicate ceramic preferably includes, but not limited to, clay, cordierite ceramics, steatite, stoneware, earthenware, porcelain, kaolin, quartz, silica, chamotte, bentonite, mullite, and any combinations thereof.

The oxide ceramic preferably includes, but not limited to, alumina, zirconia including zirconia stabilized in yttria (Y₃O₂), beryllium oxide, yttrium oxide, titanium oxide, magnesium oxide, calcium oxide, barium oxide, zinc oxide, uranium oxide (UO₂), plutonium dioxide (PuO₂), yttrium barium copper oxide, spinel, magnetoplumbite, perovskite, tialite and any combinations thereof.

The non-oxide ceramic preferably includes, but not limited to, carbide ceramic including titanium carbide, boron carbide, tungsten carbide, silicon carbide, nitride ceramics including silicon nitride, boron nitride, aluminium nitride, aluminium oxynitride, SiAlON (ceramics based on the elements silicon (Si), aluminium (Al), oxygen (O) and nitrogen (N)) and any combinations thereof.

The bioceramic preferably includes, but not limited to, calcium phosphate ceramic including hydroxyapatite (HAP), tricalcium phosphate (TCP), amorphous calcium phosphate (ACP), octacalcium phosphate (OCP), dicalcium phosphate anhydrous (DCPA), dicalcium phosphate dihydrate (DCPD), tetracalcium phosphate monoxide (TetCp), biphasic calcium phosphate (BCP) and any combinations thereof.

The build material of the present invention may include other sinterable materials such as glass powder, acrylonitrile butadiene styrene (ABS), polylactic acid (PLA), poly ether ether ketone (PEEK), without cracking, slumping or delaminating.

The organic polymer binder employed in the present invention preferably has at least two thermal decomposition temperatures. In the thermal decomposition, a decomposition product (i.e., the functionally graded article) capable of acting as a reductant is formed upon heating of the same containing the said organic polymer binder at those temperatures. The said organic polymer binder is preferably selected so as not to inhibit the reaction between the particles of the powders, i.e., the metal and/or the ceramic. It is preferred that the said organic polymer binder decomposes or evaporates at a temperature less than the thermal decomposition temperatures associated thereof.

The organic polymer binder is preferably selected from a group comprising a cellulose ester, a cellulose ether, and derivatives thereof. It is preferred that the organic polymer binder is employed in a concentration from about 150 g/L to about 550 g/L, more preferably from about 200 g/L to about 500 g/L. In various embodiments of the present invention, the organic polymer binder comprises a number average molecular weight of not more than about 150,000, more preferably not more than about 100,000.

It is preferred that the cellulose ester is selected from a group comprising a cellulose acetate, a cellulose acetate phthalate, a cellulose diacetate, a cellulose triacetate, a cellulose acetate butyrate, a cellulose butyrate, a cellulose tributyrate, a cellulose acetate propionate, a cellulose propionate, a cellulose tripropionate, a cellulose nitrate, a cellulose acetate propionate, a carboxymethyl cellulose acetate, a carboxymethyl cellulose acetate propionate, a carboxymethyl cellulose acetate butyrate, a cellulose acetate butyrate succinate, a cellulose propionate butyrate, and mixtures thereof.

The cellulose ester derivatives may be prepared by esterification of cellulose. The preferred cellulose ester derivatives include acetates, butyrates, benzoates, phthalates and anthranilic acid esters of cellulose, preferably, cellulose acetate phthalate (CAP), cellulose acetate butyrate (CAB), cellulose acetate trimelitate (CAT), hydroxylpropylmethyl cellulose phthalate (HPMCP), succinoyl cellulose, cellulose fuoroate, cellulose carbanilate, and mixtures thereof.

It is preferred that the cellulose ether is selected from a group comprising a methyl cellulose, an ethyl cellulose, a hydroxyethyl cellulose, a hydroxypropyl cellulose, a methylhydroxyethyl cellulose, a methylhydroxypropyl cellulose, an ethylhydroxyethyl cellulose, a methylethylhydroxyethyl cellulose, a hydrophobically modified ethylhydroxyethylcellulose, a hydrophobically modified hydroxyethylcellulose, an alkyl cellulose, a hydroxyalkyl cellulose, a carboxyalkyl cellulose, a carboxyalkyl hydroxyalkyl cellulose and mixtures thereof.

The cellulose ether derivatives can be prepared by carboxymethylation, carboxyethylation and carboxypropylation. Examples of preferred cellulose ether derivatives are, but not limited to, nanocellulose, carboxymethyl cellulose (CMC), sodium carboxymethyl cellulose (NaCMC), hydroxypropyl cellulose (HPC), hydroxyethyl cellulose (HEC), hydroxypropylmethyl cellulose (HPMC), methyl cellulose (MC), ethyl cellulose (EC), trityl cellulose, and so on.

In some organic polymer binders, cationic cellulose derivatives may be used. Some organic polymer binders may comprise other polysaccharides such as alginates, starch, chitin and chitosan, agarose, hyaluronic acid, and their derivatives or copolymers (e.g., graft-copolymer, block copolymer, random copolymers), or mixtures thereof.

The additive employed in the present invention may be added to the build material and the organic polymer binder thereof to achieve any desired properties such as the desired physical, mechanical and thermal properties in the slurry feedstock. In a preferred embodiment of the present invention, the additive is selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof. It is preferred that the additive is employed in an amount from about 1 vol. % to about 15 vol. %. It is understood that the amount of the additive may vary, possible outside the said range, depending upon the particular type of additive chosen in the present invention.

The plasticizer preferably means a substance added to the slurry feedstock to improve workability, flexibility and plasticity of the same. The plasticizer preferably comprises one or more organic additives including, but is not limited to, phtalates such as, dibutyl phthalate, diaryl phthalate, diethyl phthalate, dimethyl phthalate, dihexyl phthalate, di-2-methoxyethyl phthalate, triphenyl phthalate, (dipropylene glycol) butyl ether, dibutyl tartrate, diethyleneglycolmonoricinoleate, a natural or synthetic wax selected from the group comprising cetyl alcohol, stearylalcohol, cetostearylalcohol, bees wax, candellila wax, shellac wax, carnauba wax, or petroleum wax or a mixture thereof, glycerol, triethyl citrate, acetyl triethyl citrate, ethyl o-benzoylbenzoate, ethyl phthalyl ethyl glycolate, methyl phthalyl ethyl glycolate, N-Ethyltoluenesulfonamide, o-Cresyl p-toluenesulfonate, triethyl phosphate, triphenyl phosphate and any combinations thereof.

The defoaming or defoamer agent is preferably a substance that eliminates foam by reducing a surface tension of the slurry feedstock. The defoaming agent plays the role of changing the surface characteristic of the metal and the ceramic and reducing the interfacial tension of the volatile organic solvent to remove foams. The defoaming agent is preferably selected from a group comprising a polyethylene glycol, a polypropylene glycol copolymer, an alkyl poly acrylate, a poly dimethyl siloxane (silicone oil), an ethylene bis stearamide (EBS), a paraffin wax, an ester wax, a fatty alcohol wax, a white oil or vegetable oil, waxes with a long chain fatty alcohol, a fatty acid soap, an ester, a polyether modified polysilicane and a tri-alkane/alkene phosphate and mixtures thereof.

The dispersion agent is preferably a component acting for maintaining the metal and the ceramic to be mutually dispersed in the slurry feedstock. The dispersion agent is preferably a compound selected from the group consisting of silicate compounds, sodium polycarbonate, and alcohols.

The sacrificial material is preferably a material that, if present in a green or brown part prior to sintering, will not be present, at least in the same form, in any significant quantity within the fully sintered body (i.e., the final part) formed by sintering the brown part to a final functionally graded article or a final part. In an embodiment, it forms a layer of material on the green or brown part where that material is later removed to leave a void. The sacrificial material may comprise aluminium orthophosphate that, as the temperature is raised during a sintering process, will initially result in the formation of a liquid phase within the green or brown part, and that will subsequently vaporize, decompose, or otherwise leave the green or brown part as one or more gaseous byproducts. The sacrificial material preferably includes a paraffin wax.

The fugitive material is preferably a material that can function as a mould for casting a ceramic part and/or a metal part within the three-dimensional structure of the functionally graded article and which can then be removed from the ceramic cast part and/or the metal part by dissolving, melting and/or vaporization without harming the ceramic and/or metal cast part. The fugitive material employed in the present invention may be a rubber or plastic material that may be selected to achieve desired properties, such as thermal expansion (relative to the ceramic or metal core material) and/or its mode of being made fugitive.

In an embodiment, the sacrificial material, the fugitive material or a combination thereof is removed from the preliminary part or the preliminary part having the organic polymer binder debound therefrom (i.e., the brown part) through a thermal decomposition, a solvent debinding or any combinations thereof. It is preferred that the thermal decomposition can be selected from a group comprising heating, thermal debinding, densification/sintering, partial or complete melting of the sacrificial material and/or the fugitive material other than the build material, i.e., the metal particles and/or the ceramic particles. The said solvent debinding may involve immersion of the preliminary part, the brown part and/or the final part into a solvent which dissolves the sacrificial material and/or the fugitive material thereof. It is possible to reduce the time of debinding considerably with a better control of distortion. The said solvent includes, but not limited to, n-hexane, heptane, thinner, acetone, methylethyl ketone, carbon tetrachloride, trichloroethylene, methylene chloride, and alternative solvents, such as supercritical carbon dioxide, and water and the like.

The scaffolding material is preferably a buttressing material to add mechanical integrity to the slurry feedstock thereof. The said scaffolding material may be selected from a group comprising gel-like materials such as chitosan, fibrin, modified alginates, sturdier materials such as polycaprolactone and other plastics, and slurries containing ceramic and other powders, hydroxyapatite, or tricalcium phosphate. The scaffolding material also may include poly-caprolactone, polylactic acid, polyglycolic acid, and poly(lactide-co-glycolide).

The water-soluble inorganic salt employed in the present invention is preferably selected from a group comprising a nitrate salt, a borate salt, a chlorate salt, a perchlorate salt, a sulfate salt, a halide salt, a sodium carbonate, a potassium carbonate, a silicate salt, a phosphate salt, a salt of Group I element, an ammonium salt and combinations thereof. In an embodiment, the water-soluble inorganic salt includes a rare earth metal chloride.

The foaming or blowing agent preferably refers to a component, or a combination of components, which are capable of forming a foam, preferably a generally cellular foam structure in the slurry feedstock, particularly in the metal and/or the ceramic of the build material thereof. The foaming agent may be a solid, a liquid, or a supercritical material.

In a preferred embodiment of the present invention, the foaming agent is a heat-decomposable agent which is liquid or solid at room temperature that has a lower decomposition temperature than the melting temperature of the build material and, when heated to a temperature above the decomposition temperature, decomposes while evolving a gas such as nitrogen, carbon dioxide or ammonia. The foaming agent may be selected from a group comprising azodicarbonamide and/or metal salts thereof, hydrazodicarbonamide, sodium bicarbonate, ammonium carbonate, ammonium bicarbonate, calcium azide, trihydrazino-sym-triazine, pp′-oxybis-benzenesulfonylhydrazide, dinitrosopentamethylene tetramine, azobisisobutyl-odinitrile, toluenesulfonyl hydrazide, p-toluenesulfonyl hydrazide, benzenesulfonyl hydrazide, bisbenzenesulfonyl hydrazide, p,p′-oxybis(benzenesulfonylhydrazide), azobisisobutyronitrile, barium azodicarboxylate and combinations thereof. A polysaccharide foaming agent preferably includes an arrowroot powder, a tapioca starch, a potato starch, a wheat, a rice and a maize powder. The amount of the foaming agent can be determined according to the desired expansion factor.

The graphene as the additive employed in the present invention is preferably a polycyclic aromatic molecule formed by covalently bonding multiple carbon atoms. The covalently bonded carbon atoms form a six-member carbon ring as a repeating unit and may further include a five-member carbon ring and/or a seven-member carbon ring. In the present invention, graphene is not limited to a single layer graphene but also encompasses a multi-layer graphene having, for instance, up to 10 single graphene layers. The graphene preferably includes pure or native graphene in addition to modified graphene, such as graphene oxide or amide modified graphene.

The graphene oxide, also known as “graphitic acid” and “graphite oxide”, employed in the present invention may include a structure in which a functional group containing oxygen such as a carboxyl group, a hydroxyl group, or an epoxy group is bonded onto graphene, but may not be limited thereto, in variable ratios, and which may be obtained by treating graphite with strong oxidizers. In an embodiment of the present invention, the graphene oxide includes a nanocomposite comprising graphene oxide. The graphene oxide also includes reduced graphene oxide, which is reduced forms of graphene oxide, such as graphene oxide that has been subjected to a reduction process, thereby partially or substantially reducing it. The reduced graphene oxide also refers to graphene oxide decreased in a percentage of oxygen through a reduction process.

Other additives such as a flame retardant, a toner, a release additive, a stabilizer, an anti-static agent, an impact modifier, a colourant, an antioxidant, and a mould release agent may be used in the present invention.

The volatile organic solvent, which is chemically inert to the build material thereof, preferably evaporates or is released during or after the printing by the system of the present invention. The volatile organic solvent is required to thoroughly dissolve the components of the slurry feedstock other than the build material (e.g., the organic polymer binder), and also serve as a wetting agent for preventing clogging of a print nozzle of the print head of the system of the present invention. It is also desirable to use a volatile organic solvent that promotes variations of the build material (i.e., the metal and the ceramic) in composition, structure including infill pattern or any combinations thereof of the functionally graded article and has a relatively high flashing point and small odour. The volatile organic solvent is preferably a solvent having a low vapour pressure of more than about 0.133 mbar or 13.3 Pa (0.1 mmHg) at about 20° ° C.

It is preferred that the volatile organic solvent is employed in an amount from about 1 vol. % to about 50 vol. %. In one embodiment of the present invention, an appropriate amount of the volatile organic solvent should be employed in the organic polymer binder thereof, in view of a preferred or desired concentration of the resulting solution which is the second pre-mix being the organic polymer binder solution.

The volatile organic solvent is preferably selected from a group comprising a ketone including an acetone, a butanone, a methyl ethyl ketone, a methyl amyl ketone, a methyl isobutyl ketone and a cyclohexanone, an aliphatic hydrocarbon, an aromatic hydrocarbon, an alcohol including a methanol, an ethanol, a propanol, an isopropyl alcohol and a butanol, a methyl formate, an ethylene carbonate, a propylene carbonate, a diethyl carbonate, a dimethyl carbonate, an ethyl methyl carbonate, a propylene carbonate, a 1,2-dimethoxy ethane and a γ-butyrolactone, an ethyl acetate, an isopropyl acetate, an ethyl ether, a methyl tert-butyl ether, a tetrahydrofuran, a diozane, a nitromethane, an acetonitrile, a methyl cyclohexane, an n-heptane, an n-hexane, a cyclohexane, a dipropylene glycol n-butyl ether and mixtures thereof.

In various embodiments of the present invention, the build material mixed with the additive preferably forms a first pre-mix and the organic polymer binder dissolved with or in the volatile organic solvent (i.e., the organic polymer binder solution) forms a second pre-mix. The first pre-mix and the second pre-mix are preferably mixed to form a substantially homogeneous and flowable slurry mixture that is then printed as a preliminary part of the said functionally graded article. It is preferred that the second pre-mix is in an amount from about 10 vol. % to about 90 vol. %, more preferably from about 10 vol. % to about 70 vol. %.

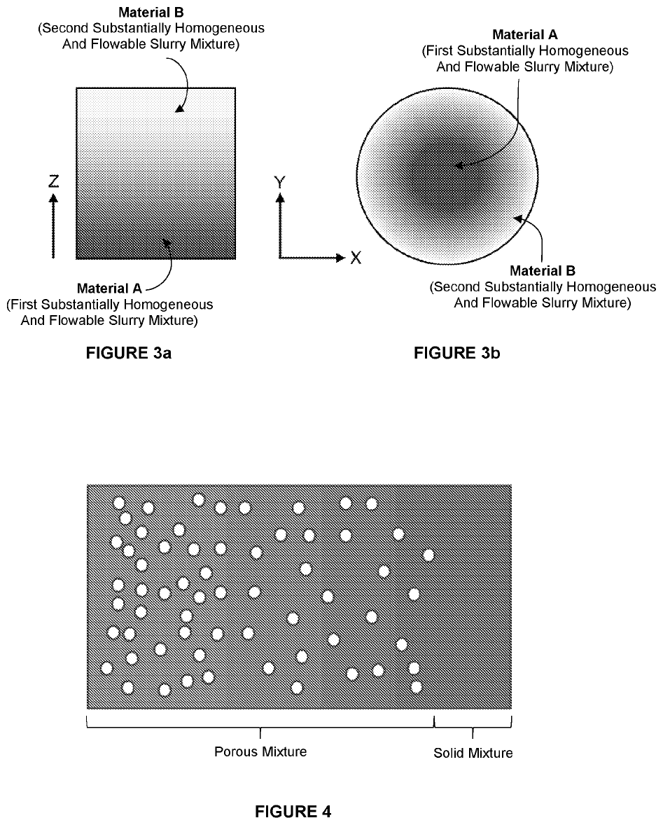

The mixing thereof preferably forms or produces a substantially homogeneous and flowable slurry mixture that is printed through the system of the present invention as a preliminary part of the said functionally graded article. FIGS. 3a, 3b, 4, 5a and 5b accordingly provide the illustrations pertaining to the functionally graded article produced by the present invention. The substantially homogeneous and flowable slurry mixture of the present invention may refer to a composition to be evenly mixed having substantially one morphological phase in the same state so that at least two random samples of the composition have roughly or substantially the same amount, concentration and distribution of the components (e.g., the build material, the organic polymer binder, the additive and/or the volatile organic solvent) therein. The substantially homogeneous and flowable slurry mixture of the present invention is also meant to encompass a composition having the components (e.g., the build material, the organic polymer binder, the additive and/or the volatile organic solvent) which are flowable under gravity and/or may be pumped. Also, the substantially homogeneous and flowable slurry mixture denotes the ability of a composition to be transported by gravity or by conventional mechanical, hydraulic or pneumatic pumping means from a storage vessel, such as a receptacle.

In one preferred embodiment, the substantially homogeneous and flowable slurry mixture includes two or more substantially homogeneous and flowable slurry mixtures. The two or more substantially homogeneous and flowable slurry mixtures are instantaneously mixed in situ in a static or active mixer to form one substantially homogeneous and flowable slurry mixture, as schematically shown in FIG. 2. Each of the said two or more substantially homogeneous and flowable slurry mixtures preferably comprises a respective first pre-mix and a respective second pre-mix. For instance, there are two substantially homogeneous and flowable slurry mixtures, namely a first substantially homogeneous and flowable slurry mixture and a second substantially homogeneous and flowable slurry mixture. The first substantially homogeneous and flowable slurry mixture preferably comprises a first pre-mix comprising a metal being the build material mixed with a dispersing agent being the additive, and a second pre-mix comprising a cellulose ester being the organic polymer binder dissolved in an acetone being the volatile organic solvent. The second substantially homogeneous and flowable slurry mixture preferably comprises a first pre-mix comprising a ceramic being the build material mixed with a foaming agent being the additive, and a second pre-mix comprising a cellulose ether being the organic polymer binder dissolved in a butanone being the volatile organic solvent. The resulting first and second substantially homogeneous and flowable slurry mixtures are mixed in the said single static or active mixer to form a single substantially homogeneous and flowable slurry mixture prior to being extruded.

One will appreciate that the term “in-situ” means at the site of mixing or providing the mixing, or on-site mixing. Thus, in order to form a slurry feedstock at the site of mixing, the build material, the organic polymer binder, the additive and/or the volatile organic solvent are generally co-injected (co-delivered) or otherwise applied together to a single static or active mixer (target site) therewithin and allowed to mix or assemble together at the site of co-injection within the said single static or active mixer.

One will also appreciate that the term “instantaneously” or “instantaneous” means time required for mixing the build material, the organic polymer binder, the additive, the volatile organic solvent, the build material mixed with the additive and/or the organic polymer binder dissolved with or in the volatile organic solvent (i.e., the organic polymer binder solution) to prepare the slurry feedstock thereof in the single static or active mixer thereof. In the present invention, such instantaneous mix may occur during a time interval from fractions of a second to several seconds. As compared to the total time of the process (up to several minutes), the mixing for fractions of seconds may be considered very rapid or instantaneous.

One will further appreciate that the term “single static or active mixer” as used herein refers to a single unit of static or active mixer rather than, as in the prior art, to multiple, non-operationally linked random mixers.

In various embodiments of the present invention, the organic polymer binder is preferably debound from the preliminary part in a thermal decomposition treatment based on the said thermal decomposition temperature, a solvent debinding treatment or a combination thereof. It is preferred that the thermal decomposition treatment can be selected from a group comprising heating, thermal debinding, densification/sintering, partial or complete melting of the components other than the build material, i.e., the metal particles and/or the ceramic particles, potentially post-densification annealing to relieve or even enhance residual stresses within the preliminary part. In certain embodiments, the thermal decomposition treatment of heating may be effected at either room temperature, or at temperatures and associated times lower than normal heat-treating times and temperatures, for example, from about 60° ° C. to about 200° C. for periods of about 10 minutes to about 1 hour.

The said solvent debinding treatment of the preliminary part may involve contacting the preliminary part with a solvent to extract dissolvable binders (along with additives, if any) from the body. Suitable solvents for the solvent debinding, according to the present invention, preferably includes acetone, methylethyl ketone, heptane, carbon tetrachloride, trichloroethylene, methylene chloride, and alternative solvents, such as supercritical carbon dioxide, and water.

The said thermal decomposition treatment and/or and the said solvent debinding treatment of the preliminary part, which is followed by sintering thereby, produces a final part of the functionally graded article. The final part preferably contains the build material having selectively varied in composition, structure including infill pattern or any combinations thereof gradually over a volume of the final part thereof in one or more directions forming a three-dimensional structure. It is preferred that the variations in the composition, structure including infill pattern or any combinations thereof are in a gradual manner which refers to changes or deviations that occur continuously or in small steps over a given nonzero distance within the volume thereof. The said one or more directions preferably include any spatial directions (x, y and/or z) in space relative to a reference point system of the said functionally graded article.

The slurry feedstock of the present invention preferably further comprises a support material. The support material preferably forms a substantially homogeneous and flowable support mixture configured for printing a support structure for an overhanging or cantilevered portion of the said functionally graded article. The support structure is part of the essential elements to allow fabrication of a complex geometry using additive manufacturing.

The support structure or layer is typically built underneath the overhanging portion or in cavities of the preliminary part of the said functionally graded article under construction, which is not supported by the part material itself. The support structure may be built utilizing the same deposition techniques by which the substantially homogeneous and flowable slurry mixture is deposited. A host computer may generate an additional geometry acting as a support structure for the overhanging or free-space segments of the preliminary part of the said functionally graded article being formed. The said support material is then deposited from the same print head (as with the substantially homogeneous and flowable slurry mixture) or another print head or nozzle pursuant to the generated geometry during the printing process. The support material can be printed with the use of a single nozzle or multiple nozzle setup. The support material adheres to the part material during fabrication, and is removable from the completed preliminary part of the said functionally graded article when the printing process is complete.

It is preferred that the said support material comprises a ceramic, a sacrificial material, a fugitive material or any combinations thereof. In an embodiment of the present invention, the support material preferably has a particle size more than about 75 μm. According to one representative embodiment, the ceramic, the sacrificial material and/or the fugitive material preferably forms a first pre-mix, and an organic polymer binder is dissolved with a volatile organic solvent to form a second pre-mix. The said first pre-mix and the said second pre-mix are added together to form a substantially homogeneous and flowable support mixture.

It is preferred that the thermal decomposition treatment and/or the solvent debinding treatment and/or the sintering process is capable of inhibiting bonding between the support structure and the preliminary part of the functionally graded article. Therefore, a sintered functionally graded article can be removed from its support structure easily.

In one embodiment of the present invention, for a metal-dominant functionally graded article, it is preferred to employ a substantially homogenous and flowable ceramic as the support material. A relatively coarser ceramic powder forming the support material would result in a loosely packed structure after sintering which is brittle and would not fuse well with the functionally graded article. It hence requires a minimal effort to remove the support structure from the functionally graded article. In one embodiment of the present invention, for a ceramic-dominant functionally graded article, it is preferred to employ a substantially homogenous and flowable sacrificial material such as an inorganic salt as the support material. The support material can be easily removed during the solvent debinding process using water. The preliminary part of the functionally graded article is then buried in a relatively coarser alumina powder for the thermal decomposition and sintering process to form the final functionally graded article.

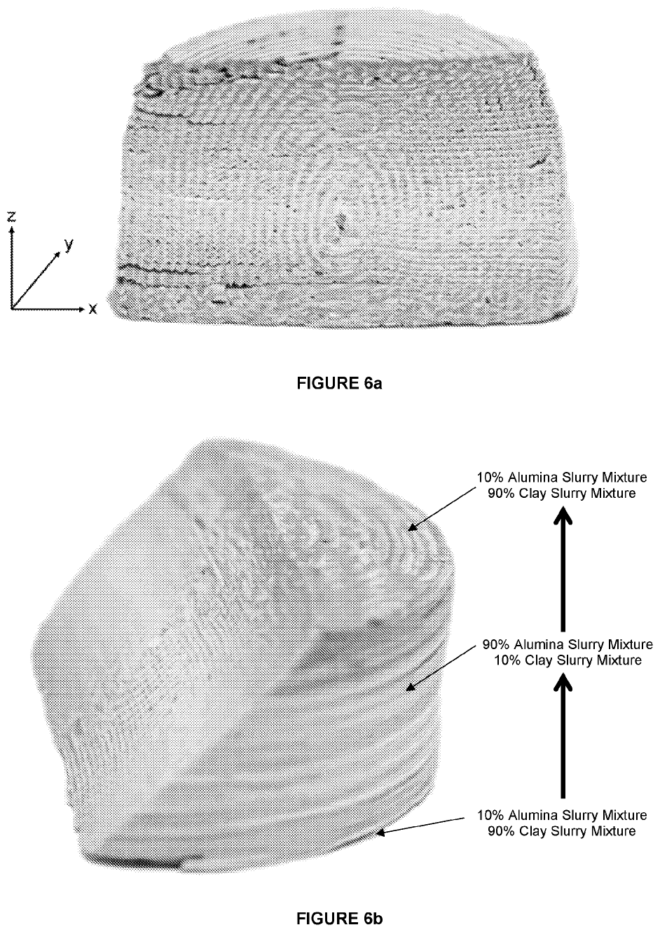

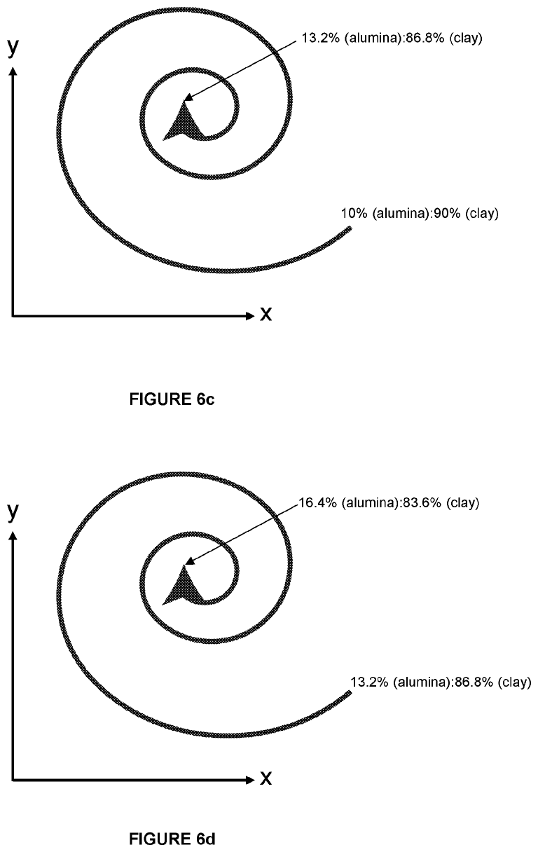

FIGS. 6a, 6b, 6c and 6d exemplarily show the green sample or part of the functionally graded article produced by the present invention. In these figures, the green part demonstrates a unique FGM transition gradient where it varies in a continuous transition of spiral concentric shape form in an x-y plane and also in a z-direction. It is preferably started from a base with a 10% alumina slurry mixture and a 90% clay slurry mixture that has a smooth transition to a middle section having a 90% alumina slurry mixture and a 10% clay slurry mixture, then at a top section with a 10% alumina slurry mixture and a 90% clay slurry mixture. The darker shade and the lighter shade of the green part in FIGS. 6a and 6b demonstrate the clay-dominant mixture and the alumina-dominant mixture, respectively. The following composition may be practical to achieve the said green part:

TABLE 1
First Mixture Composition

| Mixture Composition | Vol. % |
|---|---|
| Clay | 55 |
| Acetone + Isopropyl alcohol | 35 |
| Glycerol | 10 |

TABLE 2
Second Mixture Composition

| Mixture Composition | Vol. % |
|---|---|
| Alumina | 35 |
| Cellulose acetate (200 g/L) | 60 |
| Glycerol | 5 |

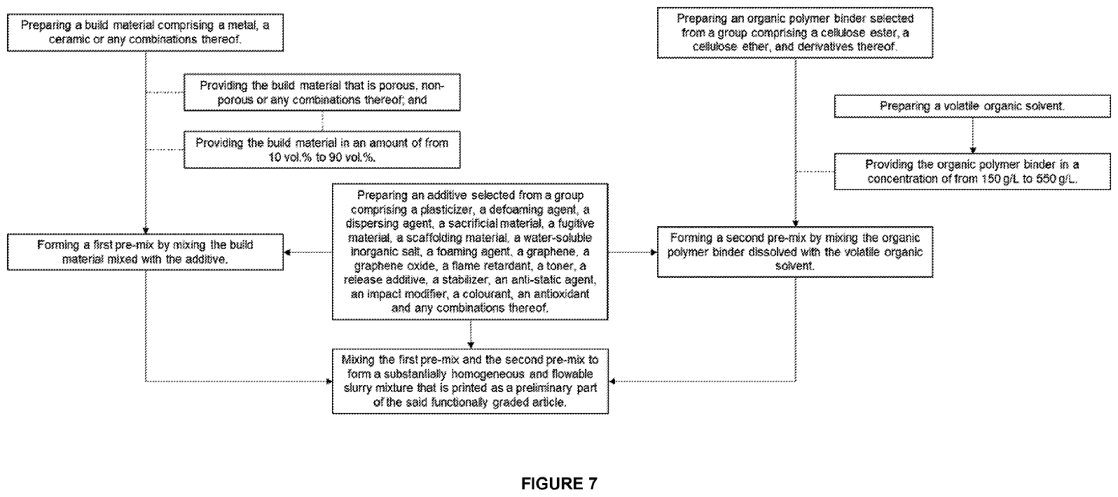

With reference to FIG. 7, the method of preparing the slurry feedstock for use in the extrusion-based 3D printing to produce a functionally graded article preferably comprises the following steps:
(a) preparing a build material comprising a metal, a ceramic or any combinations thereof, including:
   (a-1) providing the build material that is porous, non-porous or any combinations thereof; and
   (a-2) providing the build material in an amount from 10 vol. % to 90 vol. %;
(b) preparing an organic polymer binder selected from a group comprising a cellulose ester, a cellulose ether, and derivatives thereof, including:
   (b-1) providing the organic polymer binder in a concentration from 150 g/L to 550 g/L;
(c) preparing an additive selected from a group comprising a plasticizer, a defoaming agent, a dispersing agent, a sacrificial fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof;
(d) preparing a volatile organic solvent; and
(e) forming a first pre-mix by mixing the build material mixed with the additive;
(f) forming a second pre-mix by mixing the organic polymer binder dissolved with the volatile organic solvent; and
(g) mixing the first pre-mix and the second pre-mix to form a substantially homogeneous and flowable slurry mixture that is printed as a preliminary part of the said functionally graded article.

It is preferred that the method includes the step of forming two or more substantially homogeneous and flowable slurry mixtures, each comprising a respective first pre-mix and a respective second pre-mix, and the step of instantaneously mixing the two or more substantially homogeneous and flowable slurry mixtures in situ in a static or active mixer to form one substantially homogeneous and flowable slurry mixture.

As described in the preceding paragraphs, the organic polymer binder is debound from the preliminary part in either or both the thermal decomposition treatment and the solvent debinding treatment followed by sintering to thereby produce a final part of the functionally graded article containing the build material having selectively varied in composition, structure including infill pattern or any combinations thereof gradually over a volume of the final part thereof in one or more directions.

Although the method is depicted as a sequence of numbered steps for clarity, the numbering does not necessarily dictate the order of the steps. It should be understood that some of these steps may be skipped, performed in parallel, or performed without the requirement of maintaining a strict order of sequence.

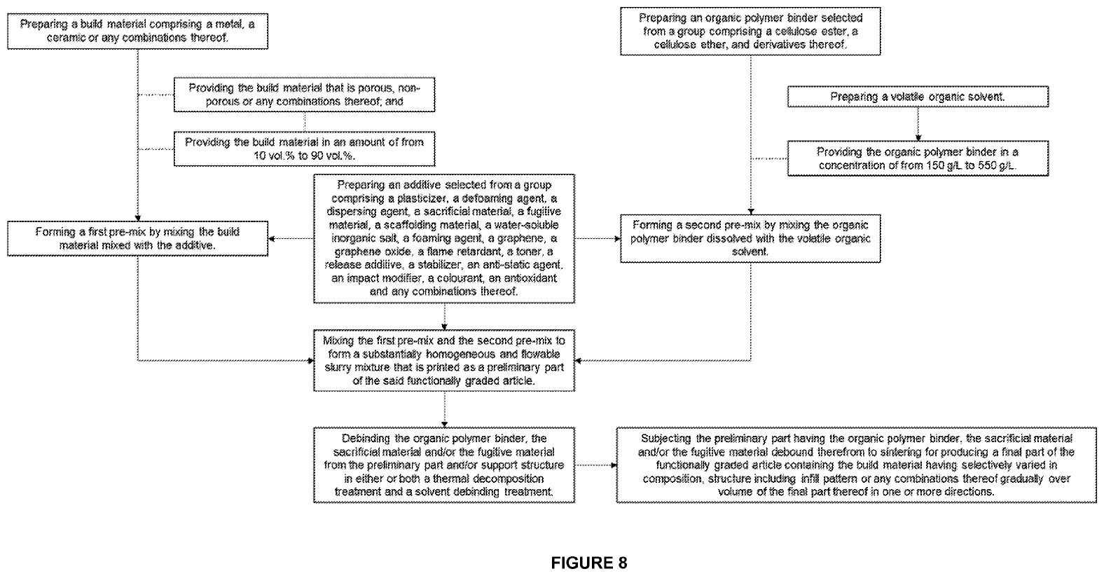

With reference to FIG. 8, the method of printing (i.e., the extrusion-based 3D printing) a functionally graded article preferably comprises the following steps:
(a) providing a slurry feedstock, including:
   (a-1) preparing a build material comprising a metal, a ceramic or any combinations thereof, including:
      (a-1-1) providing the build material that is porous, non-porous or any combinations thereof; and
      (a-1-2) providing the build material in an amount from 10 vol. % to 90 vol. %;
   (a-2) preparing an organic polymer binder selected from a group comprising a cellulose ester, a cellulose ether, and derivatives thereof, including:
      (a-2-1) providing the organic polymer binder in a concentration from 150 g/L to 550 g/L;
   (a-3) preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
   (a-4) preparing a volatile organic solvent;
(b) forming a first pre-mix by mixing the build material mixed with the additive;
(c) forming a second pre-mix by mixing the organic polymer binder dissolved with the volatile organic solvent;
(d) mixing the first pre-mix and the second pre-mix to form a substantially homogeneous and flowable slurry mixture that is printed as a preliminary part of the said functionally graded article,
(e) debinding the organic polymer binder from the preliminary part in either or both a thermal decomposition treatment and a solvent debinding treatment; and
(f) subjecting the preliminary part having the organic polymer binder debound or removed therefrom (i.e., the brown part) to sintering for producing a final part of the functionally graded article containing the build material having selectively varied in composition, structure including infill pattern or any combinations thereof gradually over volume of the final part thereof in one or more directions.

It is preferred that the method includes the step of forming two or more substantially homogeneous and flowable slurry mixtures, each comprising a respective first pre-mix and a respective second pre-mix, and the step of instantaneously mixing the two or more substantially homogeneous and flowable slurry mixtures in situ in a static or active mixer to form one substantially homogeneous and flowable slurry mixture.

Although the method is depicted as a sequence of numbered steps for clarity, the numbering does not necessarily dictate the order of the steps. It should be understood that some of these steps may be skipped, performed in parallel, or performed without the requirement of maintaining a strict order of sequence.

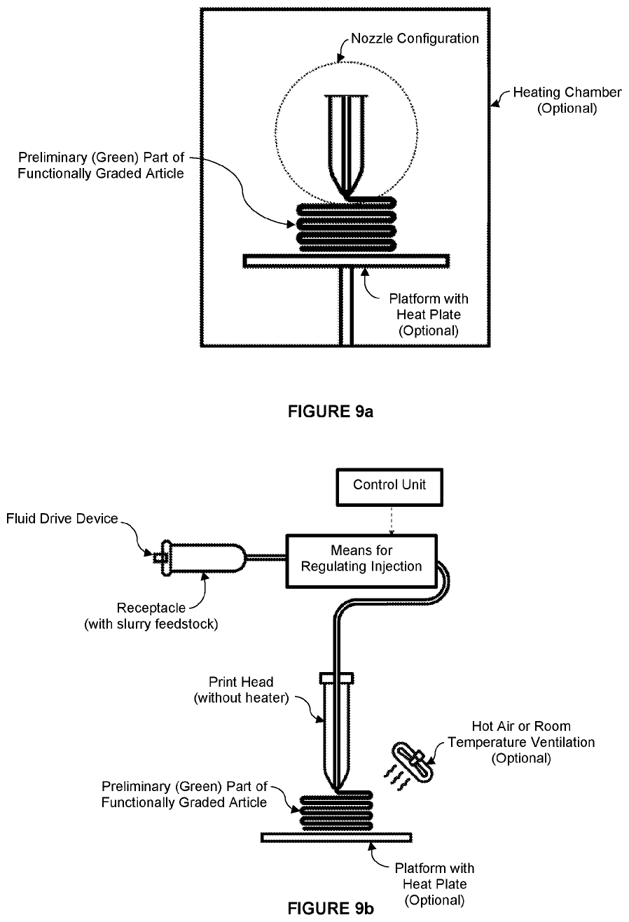

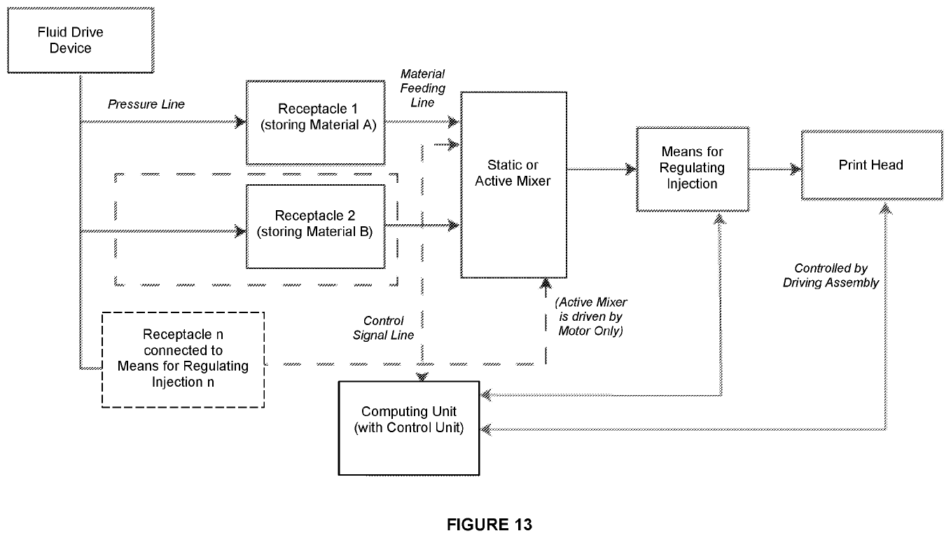

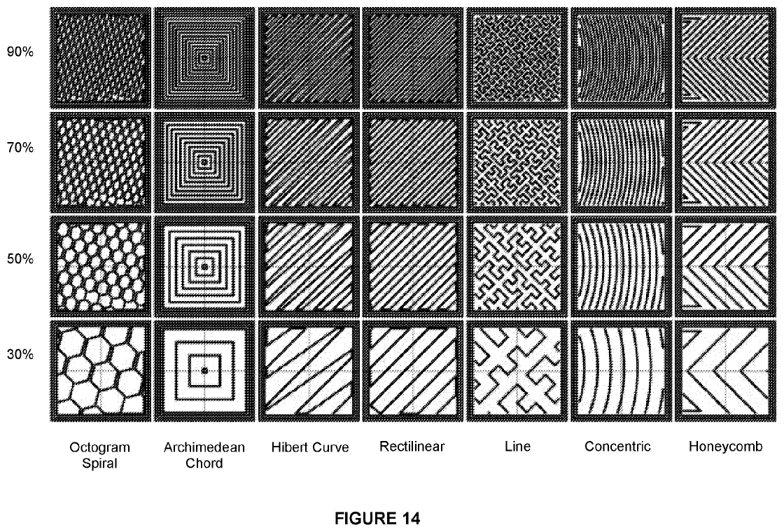

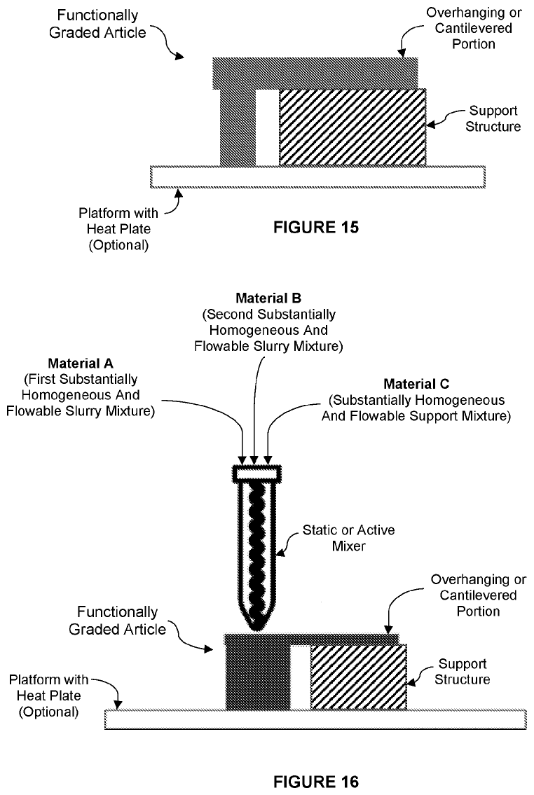

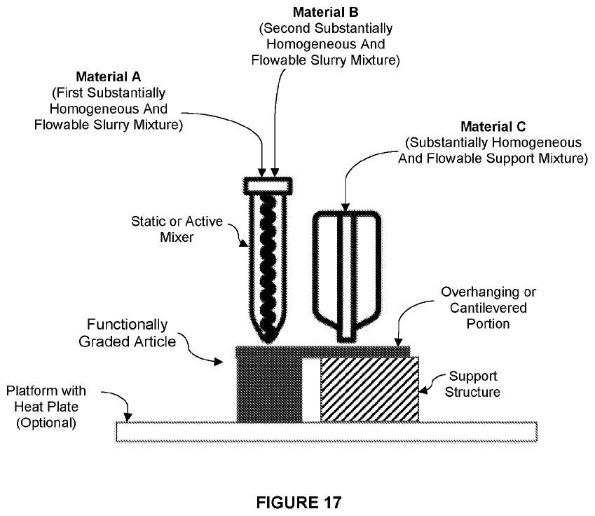

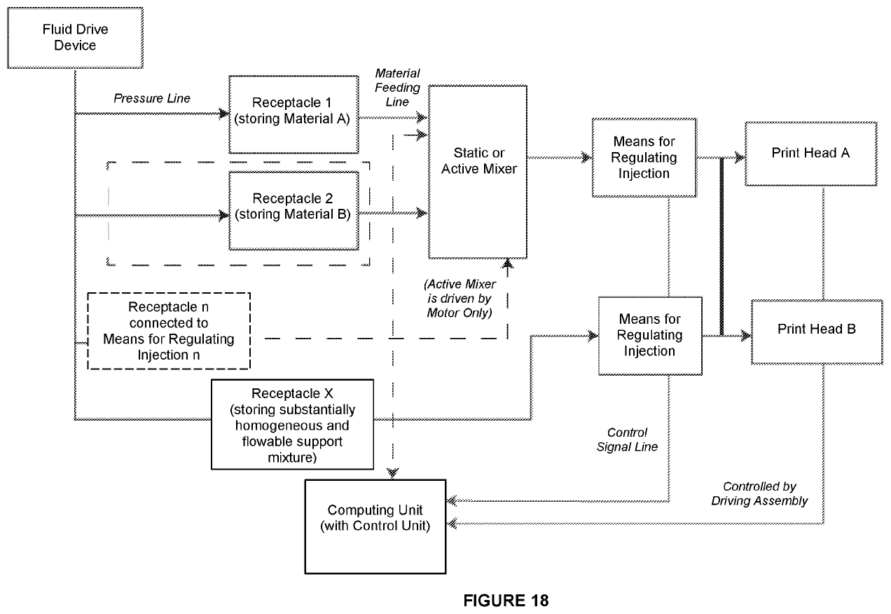

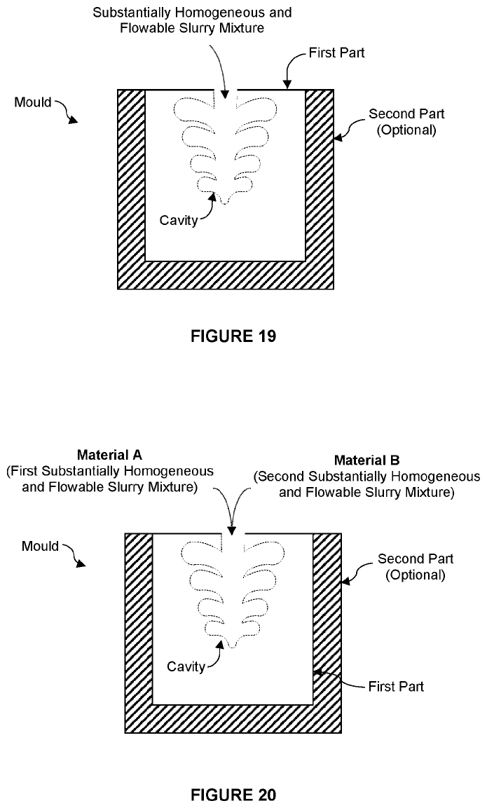

In one preferred embodiment of the present invention, the system employed for the extrusion-based 3D printing of a functionally graded article preferably comprises one or more receptacles, a means for regulating injection, a computing unit, a fluid drive device, optionally a single static or active mixer and a print head. FIGS. 9a, 9b, 10, 11, 12 and 13 illustratively provide the system of the present invention.

In FIG. 9a, the system having a predefined print nozzle configuration is preferably deployed on a flat surface or substrate (e.g., a heat plate) within a cavity of a heating chamber. A preliminary part extruded from the print nozzle will be deposited on the flat surface. The said flat surface, in an embodiment of the present invention, is a levelling platform (self or mechanical) that operatively cooperates with the print nozzle to produce the said part. The levelling platform can be computer numerically controlled by another computing unit or the same computing unit being that of the print nozzle of the print head. The heating chamber and/or the heat plate are preferably optional.

FIG. 9b shows a mechanism for the extrusion-based 3D printing to produce a functionally graded article. In the illustration, the slurry feedstock is contained in the receptacle coupled to the fluid drive device, which advances the slurry feedstock to the means for regulating injection as controlled by a control unit at the computing unit. As soon as the slurry feedstock, being the substantially homogeneous and flowable slurry mixture, is introduced at the print head, the said feedstock will be extruded through the print nozzle attached to the print head onto the flat surface, and thus, the green part of the functionally graded article is produced. The print head preferably has no heater and the like. The heat plate is preferably optional. A hot air or room temperature ventilation may be provided on an optional basis.

The one or more receptacles, or containers, tanks or vessels, are preferably configured for separately receiving a slurry feedstock and/or the components thereof as described in the preceding paragraphs. The receptacles are preferably hermetically sealed. The receptacle may be made of metal, plastic and the like, or a composite thereof, of various shapes and sizes.

In an embodiment, each of the receptacles receives the build material, the organic polymer binder, the additive and the volatile organic solvent in a separate, individual manner. For instance, there are four separate receptacles, each of which is adapted to store the build material, the organic polymer binder, the additive and the volatile organic solvent. These four receptacles are specially configured for the in situ mixings of the said components of the slurry feedstock.

In another embodiment, the metal and the ceramic of the build material are contained in different separate receptacles. For example, the metal particles are stored in the first receptacle and the ceramic particles in the second receptacle. The metal and the ceramic of the build material can be further stored in many separate receptacles, depending on, for instance, the properties of the particular metals or ceramics (e.g., physical properties, chemical properties, rheological properties, etc.), the types of the metal and/or ceramic (e.g., metal A, metal B, ceramic A, ceramic B, porous metal A, porous metal B, porous ceramic A, porous ceramic B, etc.), and the required final properties of the functionally graded article thereof. In another embodiment of the present invention, the build material can be mixed with the additive forming a first pre-mix and stored in one receptacle, and the organic polymer binder can be dissolved with or in the volatile organic solvent forming a second pre-mixed and stored in another receptacle; these two receptacles are configured for providing such mixtures (i.e., the premixed build material and additive and the pre-dissolved organic polymer binder in the volatile organic solvent) to the said static or active mixer.

In yet another embodiment, a first receptacle is configured to store the slurry feedstock which is the substantially homogeneous and flowable slurry mixture containing the build material mixed with one additive and the organic polymer binder solution, and a second receptacle is configured to store another additive mixed with the organic polymer binder solution. The said first receptacle and the said second receptacle are preferably arranged for varying a micro porosity of the functionally graded article to achieve any desired or targeted infill pattern. In this regard, the said another additive is the sacrificial material and/or the fugitive material. The aforementioned arrangement of receptacles may not be applicable for macro porosity variation.

The means for regulating injection is preferably mechanically connected to the receptacle. The means for regulating injection is preferably configured for regulating the injection rate and quantity or amount of the slurry feedstock and/or its components stored in the receptacles, for instance, by controlling the position of a control piston provided in the said means for regulating injection. It is preferred that the means for regulating injection is connected to and in communication with the control unit of the computing unit thereof.

The means for regulating injection is preferably selected from a group comprising a solenoid valve, a mechanical pump and a combination thereof.

The solenoid valve employed in the present invention refers to any device, also called a servo valve, making it possible to connect, and more particularly to put in communication, in a controlled manner, the slurry feedstock and/or its components thereof in the receptacles placed upstream of the static or active mixer with a user circuit located downstream, so as to control the pressure in this user circuit. Such a solenoid valve generally has two chambers and a slide valve controlled so as to put one of the chambers in relation, depending on its position, with a high-pressure supply circuit and the other chamber with a low-pressure fluid return circuit, one of the chambers furthermore being connected to the user circuit. It will be noted that included in the solenoid valve devices of this type are pulsators, in which the pressure source is not put directly in communication with the user circuit but is operationally connected to it via a vibrating piston, itself controlled by a solenoid valve.

The mechanical pump, or simply pump, as used herein is a broad term and is used, in accordance with its ordinary meaning, to refer to any device that can urge fluid flow, at least in the present invention, the flow of the slurry feedstock. For example, the pump can include a syringe pump, a peristaltic pump, a vacuum pump, an electrical pump, a mechanical pump, a slurry pump, a centrifugal pump, a hydraulic pump, and any combinations thereof. Pumps and/or pump components that are suitable for use with some embodiments can be obtained suitably so as to ensure effective and consistent pumping of the said slurry.

The computing unit having coupled with the control unit preferably refers to any system that includes a processor and a memory. In some embodiments, the computing unit may also contain a display. The computing unit is preferably configured for generating a control signal to the said means for regulating injection, the static or active mixer and/or the print head thereof. The said control signal is a single signal or a set of multiple signals used to control the components connected thereto. The control signal preferably can control one or more characteristics (associated with the system of the present invention) such as the injection rate, the injection quantity or amount, the interval, the deposition rate, the positioning of the print nozzle or the print head, the shape of the functionally graded articled and many more. The said control unit is preferably connected to a database comprising a predefined set of material and rheology profiles of the components utilized in the present invention. It is employed to operatively affect the control signal in respect of the final part of the said functionally graded article. For instance, the control signal is tuned according to the rheology profiles of the build material to appropriately trigger the means for regulating injection so as to apply an accurate injection rate and/or injection quantity corresponding to the said profiles and the desired functionally graded article thereof. The control unit may include a hardware device that includes a memory and a processor which is integrated with a server. The memory is configured to store the modules/units that execute instructions, and the processor is specifically configured to execute said instructions to perform one or more processes as described herein.

In some embodiments, the computing unit is a self-contained system. In some embodiments, the computing unit is not self-contained. It is preferred that the computing unit is a dedicated computer or a dedicated computing device with processing power and/or storage memory (e.g., CPU, microprocessor, etc.), which typically runs an operating software, for operating the system of the present invention (e.g., the means for regulating injection, the static or active mixer and the print head) to perform predefined printing procedures. The computing unit is either integral to the system of the present invention or is connected to the system thereof in a dedicated manner to operate the same.

In representative embodiments, the computing unit comprises a peer-to-peer module to receive a request message to a peer-to-peer application. The request message includes the data or information of the desired product, i.e., the functionally graded article, to be produced by the system of the present invention, and customization parameters.

The fluid drive device is arranged adjacently along with the said receptacle or the said means for regulating injection. The fluid drive device is preferably a pressure drive configured for providing or supplying a fluidic pressure or pressure fluid to and from a transfer mechanism to effect the movement of the slurry feedstock and/or its components thereof contained in the respective receptacles, or of the said means for regulating injection which, in turn, actuates the slurry feedstock and/or its components thereof in the one or more receptacles connected thereof to provide a pressurized slurry feedstock and/or pressurized components. It is intended that such term “fluidic pressure” be broad enough to cover any suitable fluid pressure of this character and to include vacuum.

In a preferred embodiment, the fluid drive device of the present invention can be selected from a group comprising a pneumatic drive device, a hydraulic drive device, a mechanical displacement device and the like and any combinations thereof. The said pneumatic drive device employed herein preferably encompasses any type of equipment operated by the passage of compressed air therethrough. For instance, the pneumatic drive device is a system operated by air or other gas under pressure, such as relatively low-cost but efficient rotary piston air motors and portable high-pressure pneumatic cylinders. The hydraulic drive device is preferably a hydraulic drive incorporating a hydraulic motor whether or not a separate reducer is also present. The mechanical displacement device can be used to transport the slurry feedstock to the means for regulating injection thereof. The fluid drive device also includes any other motorized displacement devices suitably adopted for the present invention.

The single static or active mixer, optionally employed in the present invention, is preferably configured for singularly, instantaneously mixing two or more substantially homogeneous and flowable slurry mixtures in situ to form one or single substantially homogeneous and flowable slurry mixture prior to transfer to the print head.

The static or motionless mixer is essentially a mixer that does not include internal moving mechanical parts. The static mixer is preferably a device that includes one or more substantially stationary mixing elements, e.g., baffles such as blades, plates, vanes, that are adapted for placement in the path of a flowing fluid, e.g., the slurry feedstock and/or its components thereof through a conduit, to produce a pattern of flow divisions and splits to accomplish mixing, e.g., radial mixing via radial circulation or exchange, in the flowing fluid. Although the stationary mixing elements are typically immovable within the conduit, some limited movement of the stationary elements relative to the conduit can occur so long as such limited movement does not contribute substantially to the mixing of the flowing fluid. In a static mixer having multiple stationary elements, these elements can be arranged in series and/or in a staggered orientation relative to one another. The static mixer is preferably selected to generate a mixed flowing stream, i.e., the substantially homogeneous and flowable slurry mixture, over a short length of the mixer. The active mixer, on the other hand, is preferably opposite of the said static mixer and it comprises moving parts. The active mixer may blend the slurry feedstock and its components thereof together after they have been or while been loaded thereto. Other mixers of similar characters could likely be used instead of the aforementioned mixer as can be appropriately selected by one skilled in the art.

The print head with the print nozzle preferably includes a chamber to hold the said substantially homogeneous and flowable slurry mixture just before the printing or extruding onto the flat surface. In light of the slurry feedstock of the present invention, advantageously, heater or the like is therefore not required at the print head. In an embodiment, the print head includes a single print head and a print bar, carriage assembly or mounting block having multiple print heads, having one or more print nozzles organized in a linear or non-linear array. It is preferred that the print head is operatively driven by the computing unit thereof configured for jetting, extruding, dispensing, depositing or generally expulsing the said substantially homogeneous and flowable slurry mixture, either directly received from the fluid drive device and/or received from the single static or active mixer, to produce a preliminary part of the said functionally graded article. The expulsion of the substantially homogeneous and flowable slurry mixture is a non-contact dispensing process that utilizes the print head to form and shoot or extrude a continuous or non-continuous stream of the slurry feedstock from the print nozzle onto a flat surface or substrate. The static or active mixer thereof can be connected to the said print head through a dispensing unit which can be controlled by another computing unit or the same computing unit thereof.

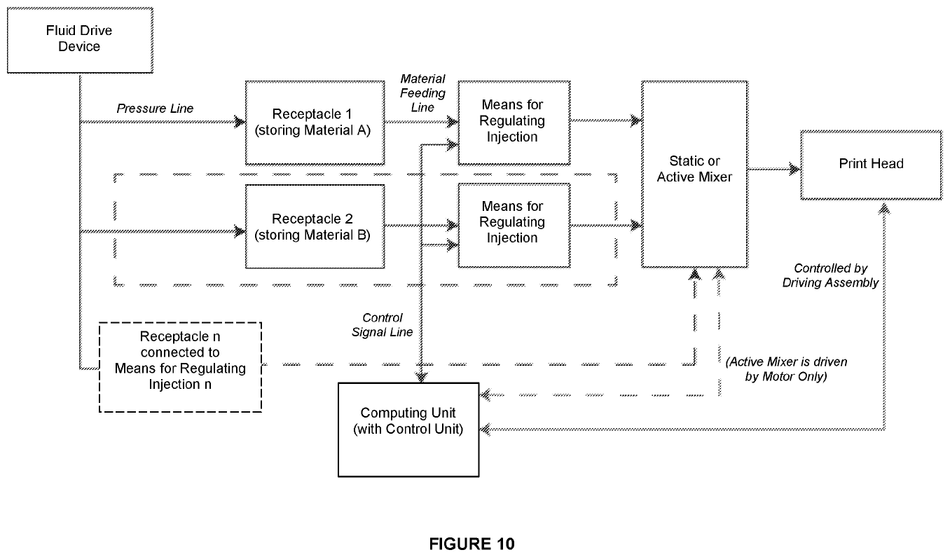

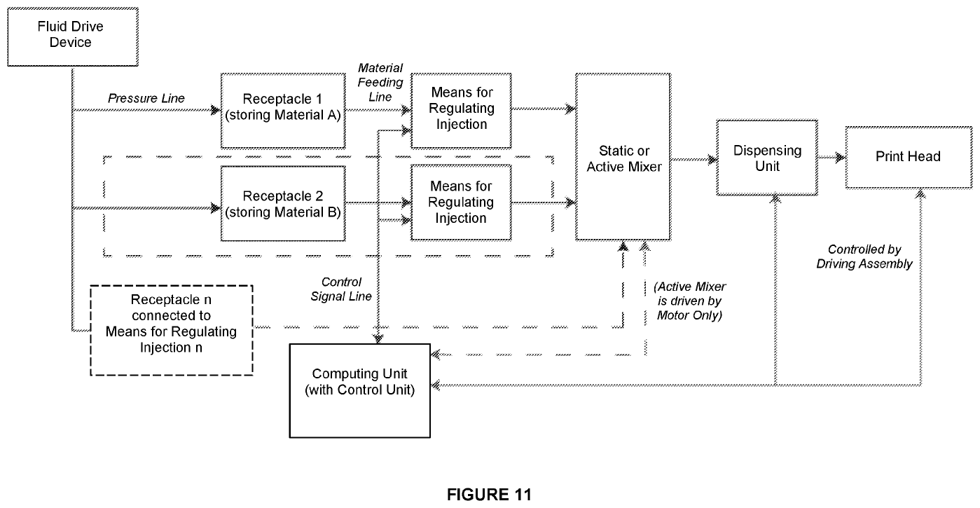

In one representative embodiment of the system of the present invention, with reference to FIG. 10, the receptacles (i.e., Receptacle 1 and Receptacle 2) are connected to the fluid drive device. The means for regulating injection is deployed between the receptacles and the single static or active mixer thereof, which is connected to the print head. The computing unit is preferably in control of the means for regulating injection, the static or active mixer and the print head thereof. The means for regulating injection is preferably a mechanical pump or the like.

In one representative embodiment of the system of the present invention, FIG. 11 is essentially the same as the arrangement of FIG. 10, except the dispensing unit is disposed between the static or active mixer and the print head thereof. In this arrangement, the computing unit is preferably in control of the means for regulating injection (i.e., the mechanical pump), the static or active mixer, the dispensing unit and the print head thereof.

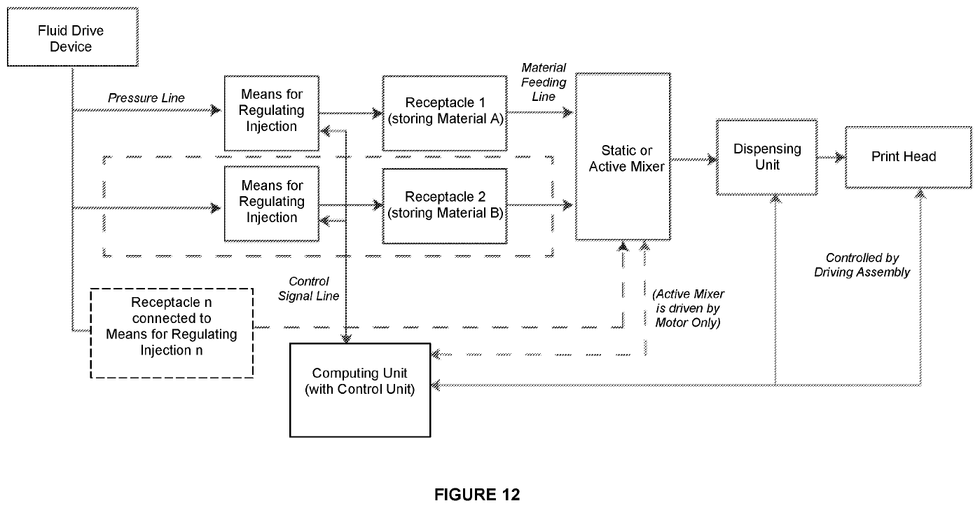

In one representative embodiment of the system of the present invention, FIG. 12 shows another arrangement that employs a solenoid valve as the means for regulating injection. The solenoid valve is positioned prior to the receptacles and connects with the fluid drive device thereof. The static or active mixer is coupled to the receptacles and the dispensing unit deployed prior to the print head thereof. The computing unit is preferably in control of the solenoid valve, the static or active mixer, the dispensing unit and the print head thereof.

The present invention will now be specifically described by the following examples, but it should be understood that the present invention is not limited in any way to these examples.

The present invention allows a person, e.g., an engineer, to create a metal A to metal B, metal A to ceramic A or ceramic A to ceramic B variation based FGM article through direct slurry writing techniques (where A and B can be any metal family group or ceramic family group). This versatile method of the present invention is capable of varying the material properties of the printed object in a three-dimensional direction (see FIGS. 3a and 3b) rather than a single direction as disclosed in the prior art and/or the conventional fabrication methods. The present invention enables full use or optimization by way of employing or utilizing the superior properties of each material to form a metal/ceramic composite that is unique to maintain functionality in extreme conditions.

The extrusion-based printing of the present invention begins with the engineering design of the CAD model and the target material profiles based on the guideline provided through the material database (example profiles coded are illustrated in FIGS. 3a and 3b) to form unique properties of the FGM article. Then the CAD model will be processed through a slicer program to generate Gcode (an instruction command to execute a 3D printer) for the system of the present invention. It is followed by a design post-processing software where the material profiles are integrated with the Gcode generated thereof. The post-processing tool allows the material mixing ratio to be programmed into the Gcode such that the printer can vary the mixture compositions during the printing process itself.

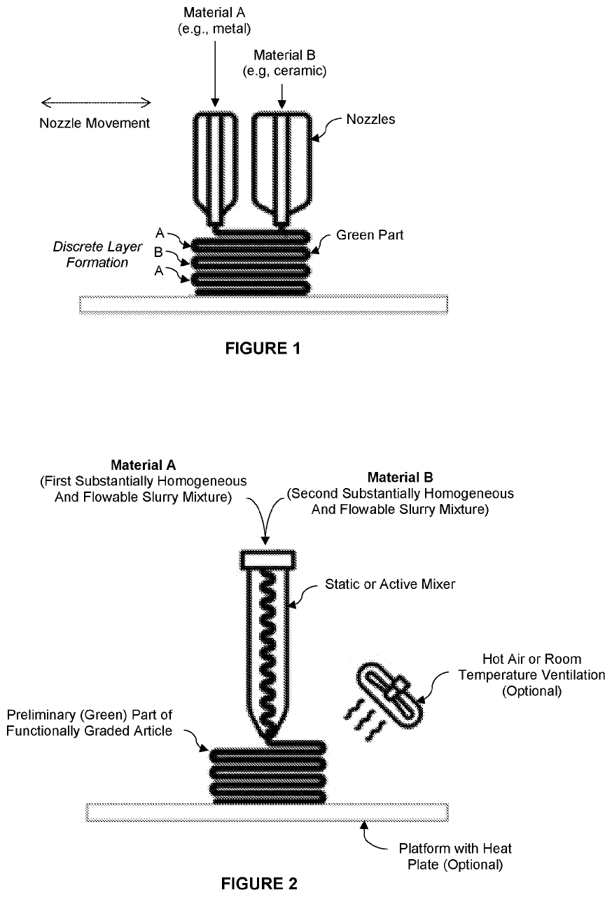

The proprietary 3D printer (which is the system of the present invention) may consist of more than one extruder, which allows the mixing of more than one type of material in the FGM printing of the present invention. The slurry feedstock will be fed into a receptacle or tank that has a pneumatic/hydraulic drive to provide the pressure to move the slurry feedstock into a mechanical pump which is driven by a motor controlled by the printer controller. The slurry feedstock will be pumped precisely into a static or active mixer depending on the viscosity of the material to be printed. Since the feedstock is in a slurry form, the mixing of more than one type of material can be easily scaled up and mixed in-situ during printing, as illustrated in FIG. 2, compared to the existing additive method or technique where the variation of the material could only be achieved in a discrete form (see FIG. 1).

The slurry mixture printing of the present invention relies on the evaporation of the solvent-based binder to form a cured printed object. Therefore, the control of the organic polymer binder's concentration and the ratio between the said binder and the binding particles (i.e., the metal and/or ceramics powders) become a crucial step to ensure the printed solution has a sufficient static yield stress to sustain its shape once extruded out of the print nozzle whilst it is still able to be mixed with the use of the static mixer (refers to as mixing of fluid without active moving parts) or the active mixer (which comprises of a rotor which mixing the fluid through active shearing mechanism) to form a homogenous slurry mixture during the printing as shown in FIG. 2. These static or active mixers have an effective viscosity working range.

In order to have an effective homogenous mixture, the slurry mixture has to be prepared such that both types of material raw stocks have a slight variation of viscosity changes across a range of shear rates. As different types of powder sizes or shapes would yield significant differences in terms of their rheological behaviours. The tuning of rheology must be performed within each material and the combination of both mixtures across all the variation mixtures. Ideally, they should be within the range of about 30-90 vol. % for the metal and/or the ceramic, about 200-500 g/L and/or 10-70 vol. % for the organic polymer binder and about 1-15 vol. % for the additive(s). An effective mixture that can vary across a large range of ratio between two materials and it is not achievable by simply mixing any two materials together. For example, to obtain a flowable mixture suitable for printing ratio of about 10-80 vol. %, it may require feedstock material A to be very viscous and material B to be very liquid in its raw state. As both slurries are non-Newtonian fluid in nature, therefore a similar shear rate or pumping rate may yield a different volumetric flow rate which results in the inaccuracy of mixture ratio as programmed by the user. Thus, in the present invention, the rheology profiles of the feedstock materials (i.e., the components of the slurry feedstock) and their mixtures must be attained and mapped through the experimental setup. These rheology profiles will be integrated with the design of the material profiles to form a unique compensation factor to be included during the post-processing of the slicer Gcode to ensure feeding volumetric flow rates of both the slurries are consistent such that a uniform mixture ratio is attainable. There is an effective mixture ratio achievable between two materials, i.e., usually in a range of about 10-90%. This allows the creation of a metal and ceramic mixture, i.e., metal A and metal B, metal A (porous mixture) and metal A (non-porous mixture), ceramic A (porous) and ceramic A (non-porous) or ceramic A and ceramic B formation depending on the need and properties of the article needed to be formed. The mixture of the material that flows through the mixer can be more than two types of materials and is not limited to that shown in any figures. This setup enables material A and material B to be mixed in a precise ratio during the printing process.

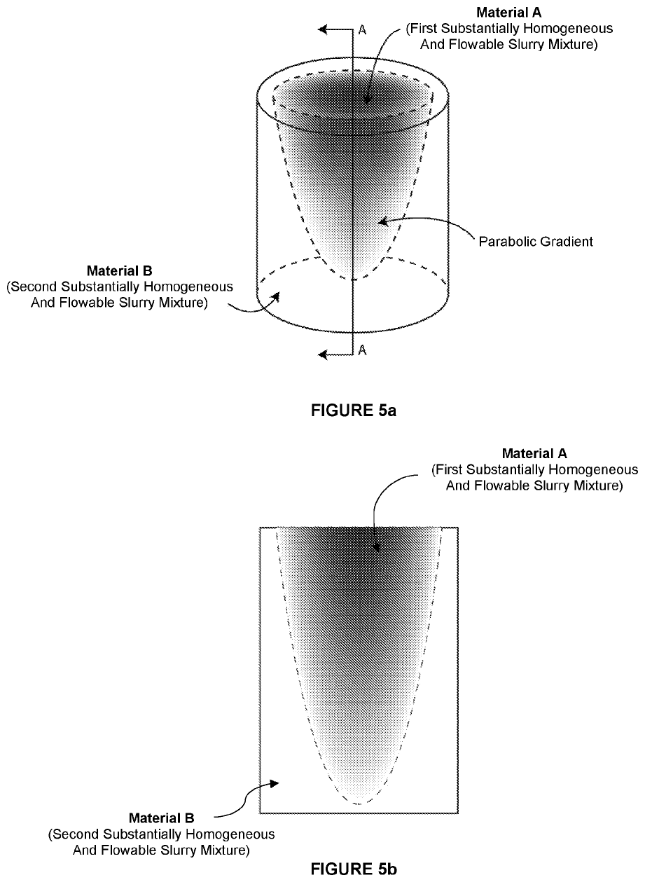

Examples of the setup are provided below:
Material A (metal/ceramic A with low concentration binder in liquid form) and material B (pure binder with additive premix). This prevents premature drying in premixed slurry material during printing with a single nozzle only (to simplify the preparation). The precise rheology behaviour of the slurry can be tuned based on the printing condition, i.e., temperature and humidity.
Material A (metal) with Material B (ceramic) mixture of both materials can be varied precisely through printer controller software three-dimensionally during printing which enables the creation of functionally graded material varies across three dimensions as shown in FIGS. 3a and 3b. It is worth noting that this can be a mixture of more than two materials, varies in one or more directions and printed in situ.
Material A (porous metal/ceramic mixture) is formulated through the addition of scaffolding non-soluble material/foaming agents with Material A (concentrated mixture), wherein Material A can be selected from a group of metal and ceramic. This allows the printing of unique structures such as the shell can be solid and infill with porous materials (see FIG. 4). The porous gradient can be controlled not only to a linear or single dimension, as illustrated in FIG. 4 but to a parabolic gradient applied across 3D spaces (see FIGS. 5a and 5b).

Definition of porous metal here may refer to metal or ceramic/metal foam/ceramic foam. The porous structure can be classified as microporous (<100 μm) and macroporous (>100 μm). In the present invention, the macroporous could be achieved by controlling an infill structure through the slicer software (can be formed in varieties of shapes such as honeycomb, adaptive cubic, triangles, star, glyroid, line, concentric, Hilbert curve, lattice structure, etc.). The present invention is capable of handling the microporous through the addition of foaming agents or sacrificial, fugitive, or scaffolding materials. This enables the control of microporous and macroporous structures printed in a single solution through the said in situ mixings of the porous mixture with the non-porous mixture. Foaming agents may result in random porous structure forming with minimal control of porous shape and structure. Mixture through the addition of sacrificial/fugitives/scaffolding materials would result in precise control of porous size, density and shape.

The following provides non-limiting combinations of the build material, which comprises the metal and the ceramic:
Metal-Metal
   (i) Al—Cu
   (ii) AL-Ni
   (iii) Ni—Ti
   (iv) 316L-H13
   (v) Ti-6Al-4V-304L
   (vi) Low carbon steel-high carbon steel
   (vii) 304-304 porous structure
Metal-Ceramic
   (i) Al—SiC
   (ii) Al—Al₂O₃
   (iii) Ni—ZrO2
   (iv) Cu—SiC
Ceramic-Ceramic
   (i) SiC—SiC (different density)
   (ii) Al₂O₃—Al₂O₃ (porous structure)
   (iii) Al₂O₃—SiC
   (iv) Al₂O₃— ZrO₂

For the FGM article involving gradual material transition (see (i)-(v) of metal-metal), the based formulation of each individual material is exemplarily tabulated in the following table. A variation of such combination can be made in a range of 0-100% for the gradient transition.

TABLE 3
Recommended Final Mixture Composition

| Mixture Composition | Vol. % |
|---|---|
| Metal/Ceramic | 30-70 |
| Organic Polymer Binder Solution | 10-80 |
| Additive | 0-50 |
| (e.g., dispersion, defoaming, foaming, wetting agents) | |

TABLE 4
Recommended Mixture of Porous Composition

| Mixture Composition | Vol. % |
|---|---|
| Metal/Ceramic | 10-50 |
| Organic Polymer Binder Solution | 10-80 |
| Additive | 10-50 |
| (e.g., dispersion, sacrificial, fugitives agents/scaffolding | |
| materials) | |

For transition between low carbon steel-high carbon steel, the following composition may be used:

TABLE 5
First Mixture Composition

| Mixture Composition | Vol. % |
|---|---|
| Fe90Cu10 | 35 |
| Cellulose acetate (400 g/L) | 59 |
| Glycerol | 6 |

TABLE 6
Second Mixture Composition

| Mixture Composition | Vol. % |
|---|---|
| Fe89Cu10C1 | 35 |
| Cellulose acetate (400 g/L) | 59 |
| Glycerol | 6 |

For a 304-304 porous structure, the porosity of the structure is controlled by the size of the crystalization of the salts. The following may be used:

TABLE 7
First Mixture Composition

| Mixture Composition | Vol. % |
|---|---|
| 304 | 35 |
| Cellulose butyrate (400 g/L) | 57 |
| Glycerol | 6 |
| Triphenyl phosphate | 2 |

TABLE 8
Second Mixture Composition

| Mixture Composition | Vol. % |
|---|---|
| Cellulose butyrate (400 g/L) | 55 |
| Glycerol | 5 |
| Sodium nitrate | 40 |

For a transition between clay and low carbon steel, the following may be used:

TABLE 9
First Mixture Composition

| Mixture Composition | Vol. % |
|---|---|
| Clay | 65 |
| Isopropyl alcohol | 25 |
| Glycerol | 10 |

TABLE 10
Second Mixture Composition

| Mixture Composition | Vol. % |
|---|---|
| Low carbon steel | 40 |
| Cellulose acetate (400 g/L) | 55 |
| Glycerol | 5 |

### Further Embodiments/Aspects

The present invention further discloses a slurry feedstock for casting an article under a low pressure at a room temperature, a method of preparing the same, a method of casting the said article, and a system therefor. Advantageously, the present invention, by virtue of the said slurry feedstock used in conjunction with a reusable mould, simplifies the conventional casting methods as the present invention does not require the use of high pressure and/or the melting of metal to enable the said casting of metal/ceramic articles. The present invention primarily focuses on a novel slurry-based feedstock prepared for metal/ceramic casting at a room temperature, and the design and configuration of a reusable mould. Since the said feedstock is in a slurry form, the present invention is further capable of avoiding a risky investment of a high-pressure injection system as the said slurry feedstock is readily flowable and movable by a gravity force (or gravitationally) or a very minimum amount of pressure for a precise casting volume control flow into the said mould. Further, the present invention can be used and maintained in a highly specific and compact, cost-effective, quick, and simple manner, without the use of complicated and sophisticated steps, components, or parts.

The term “article” as used herein refers to an article of manufacture or a semi-finished article in the form of any shaped structure that is made of or from the slurry feedstock through mould casting.

The term “slurry” as used herein refers to solid-fluid mixtures, including both solid-liquid and solid-gas mixtures. For convenience, the present invention will be discussed in terms of a solid-liquid slurry, a feedstock composition in which solids and liquid are present in separate phases. The solid-liquid slurry is input into the system of the present invention and also includes fully or partially separated solids and liquids.

The term “feedstock” as used herein is defined as a raw material or mixture of raw materials having suitable properties for being supplied to the system of the present invention from which the article can be made and shall also be interpreted as being ingredients that are yet to be mixed or further mixed in order to produce a suitable mixture for used with the mould thereof.

The term “pre-mix” as used herein refers to components that are mixed together and form one part of a blend that makes up the slurry mixture.

The term “low pressure” as used herein refers to a pressure of less or equal to 2 MPa.

The term “room temperature” as used herein indicates that no additional energy is expended in relation to the slurry feedstock or ambient temperature. In an embodiment, the term refers to a temperature range of about 20° C. to 30° C.

The term “preliminary part” or “green part” as used herein refers to an article or preform of the article, in its pre-sintered state, which is produced by the present invention to be further processed with other manufacturing technique(s).

The term “brown part” as used herein refers to an article of the article produced from the preliminary or green part that has been subjected to thermal decomposition and/or solvent debinding to remove any binders, sacrificial materials and/or fugitive materials that previously held the feedstock together. The brown part may be further heated to fully sinter the part, or subjected to sintering, to produce a final or finished part of the article.

In accordance with one preferred embodiment of the present invention, the slurry feedstock comprises a build material, an organic polymer binder, an additive (which can be optional) and a volatile organic solvent.

The organic polymer binder is preferably dissolved in the volatile organic solvent and hence, producing an organic polymer binder solution. The additive is preferably added to the build material to obtain predefined rheology behaviour and casting characteristic. The slurry feedstock essentially can be formed by way of blending the said organic polymer binder solution with the said build material mixed with the additive. The resulting slurry feedstock can be introduced into the reusable mould to dry by phase inversion at a room temperature without any external heat providing means.

The build material of the present invention preferably refers to a powder that is used to form the slurry feedstock and from which the article is built in the system for casting of the present invention. The powder, or referred to as particulate material or particles, has a varying mesh size. In an embodiment, the build material has a particle size of not more than about 300 μm, preferably less than about 200 μm. The build material is preferably a layer forming material for use in the system for casting of the present invention. The build material also may include ones in a variety of shapes such as granular powder, fibrous powder, and scale-like powder. In a preferred embodiment, the build material is employed in an amount from about 10 vol. % to about 90 vol. %, more preferably from about 30 vol. % to about 90 vol. %.

The build material preferably comprises a metal, a ceramic, or any combination thereof. In an embodiment of the present invention, the build material can be porous, non-porous, or any combination thereof. For instance, porous metal means metal particles having significant porosity, e.g., a porosity of more than about 0.5 cc/g. The build material may have pores smaller than 100 μm (microporous) and/or greater than 100 μm (mesoporous). The non-porous metal, on the other hand, implies metal particles having little or no porosity, e.g., a porosity of less than about 0.05 cc/g. The porous ceramic preferably has a porosity with controllable pore size and good mechanical properties. The term “porosity” as used herein refers to a volume fraction of void space in a porous article, such as the porous build material thereof.

The porous metal and/or the porous ceramic employed in the present invention, preferably the microporous ones, can be made by way of, for instance, direct foaming using a suitable foaming agent, sacrificial material, fugitive material, scaffolding material and the like. The porosity also can be controlled by the size of the crystallization of salts.

In one preferred embodiment of the present invention, the build material may comprise only the metal (porous and/or non-porous) or the ceramic (porous and/or non-porous). Also, the build material may include a combination of the metal and the ceramic at a predefined mix ratio or volume percentage suitably to meet the desired properties of the build material in relation to the article thereof. The combination thereof, for instance, includes those of the metal and the ceramic, the porous metal and the ceramic, the metal and the porous ceramic, the porous metal, the non-porous metal and the ceramic, the metal, the porous ceramic and the non-porous ceramic, the porous metal, the non-porous metal, the porous ceramic and the non-porous ceramic and so forth. Various other combinations (e.g., a first metal, a second metal, a first ceramic, a second ceramic, etc.) are possible.

The metal employed in the present invention is preferably selected from a group comprising a ferrous metal, a non-ferrous metal, a ferrous metal alloy, and a non-ferrous metal alloy.

The ferrous metal is selected from steel, stainless steel, mild steel, cast iron, malleable iron, ductile cast iron and the like. The ferrous metal preferably includes iron, iron-chromium alloys, iron-chromium-nickel alloys, iron-chromium-zinc alloys, iron-chromium-aluminium alloys, iron-chromium-magnesium alloys, iron-chromium-lead alloys, iron-aluminium alloys, iron-zinc alloys, stainless steels, iron-nickel alloys, and combinations thereof. Preferred examples of steel and/or stainless steel include AISI 304, AISI 304L, AISI 316, AISI 316L, AISI430, AISI 630 (17-4 PH) and AISI 631 (17-7 PH). Other steels like A2 to A5, D2, H13, M2, and 4140 also may be used in the present invention.

The non-ferrous metal is selected from aluminium, aluminium alloys, magnesium, magnesium alloys, zinc, zinc alloys, cadmium, chromium (III), copper, copper (II) cadmium, lead, cobalt, cobalt-chromium, cobalt-chromium-molybdenum, nickel, nickel alloys, molybdenum, titanium, tantalum, niobium, silver and gold. Preferred examples of aluminium and/or aluminium alloys include AlSi10Mg, AlSi7Mg, ADC12 and AlMg5Mn. Preferred examples of nickel alloys include Alloy 706, Alloy 718, Alloy 625, Alloy 725, Invar types such as FeNi36 or 64FeNi, Hastelloy X, Hastelloy C and Kovar.

The ceramic employed in the present invention is preferably selected from a group comprising a silicate ceramic, an oxide ceramic, a non-oxide ceramic, a bioceramic and any combinations thereof.

The silicate ceramic preferably includes, but not limited to, clay, cordierite ceramics, steatite, stoneware, earthenware, porcelain, kaolin, quartz, silica, chamotte, bentonite, mullite, and any combinations thereof.

The oxide ceramic preferably includes, but not limited to, alumina, zirconia including zirconia stabilized in yttria (Y₃O₂), beryllium oxide, yttrium oxide, titanium oxide, magnesium oxide, calcium oxide, barium oxide, zinc oxide, uranium oxide (UO₂), plutonium dioxide (PuO₂), yttrium barium copper oxide, spinel, magnetoplumbite, perovskite, tialite and any combinations thereof.

The non-oxide ceramic preferably includes, but not limited to, carbide ceramic including titanium carbide, boron carbide, tungsten carbide, silicon carbide, nitride ceramics including silicon nitride, boron nitride, aluminium nitride, aluminium oxynitride, SiAlON (ceramics based on the elements silicon (Si), aluminium (Al), oxygen (O) and nitrogen (N)) and any combinations thereof.

The bioceramic preferably includes, but not limited to, calcium phosphate ceramic including hydroxyapatite (HAP), tricalcium phosphate (TCP), amorphous calcium phosphate (ACP), octacalcium phosphate (OCP), dicalcium phosphate anhydrous (DCPA), dicalcium phosphate dihydrate (DCPD), tetracalcium phosphate monoxide (TetCp), biphasic calcium phosphate (BCP) and any combinations thereof.

The build material of the present invention may include other sinterable materials such as glass powder, acrylonitrile butadiene styrene (ABS), polylactic acid (PLA), poly ether ether ketone (PEEK), without cracking, slumping or delaminating.

The organic polymer binder employed in the present invention preferably has at least two thermal decomposition temperatures. In thermal decomposition, a decomposition product (i.e., the article) capable of acting as a reductant is formed upon heating of the same containing the said organic polymer binder at those temperatures. The said organic polymer binder is preferably selected so as not to inhibit the reaction between the particles of the powders, i.e., the metal and/or the ceramic. It is preferred that the said organic polymer binder decomposes or evaporates at a temperature less than the thermal decomposition temperatures associated thereof.

The organic polymer binder is preferably selected from a group comprising a cellulose ester, a cellulose ether, and derivatives thereof. It is preferred that the organic polymer binder is employed in a concentration from about 50 g/L to about 550 g/L, more preferably from about 100 g/L to about 500 g/L. In various embodiments of the present invention, the organic polymer binder comprises a number average molecular weight of not more than about 150,000, more preferably not more than about 100,000.

It is preferred that the cellulose ester is selected from a group comprising a cellulose acetate, a cellulose acetate phthalate, a cellulose diacetate, a cellulose triacetate, a cellulose acetate butyrate, a cellulose butyrate, a cellulose tributyrate, a cellulose acetate propionate, a cellulose propionate, a cellulose tripropionate, a cellulose nitrate, a cellulose acetate propionate, a carboxymethyl cellulose acetate, a carboxymethyl cellulose acetate propionate, a carboxymethyl cellulose acetate butyrate, a cellulose acetate butyrate succinate, a cellulose propionate butyrate, and mixtures thereof.

The cellulose ester derivatives may be prepared by esterification of cellulose. The preferred cellulose ester derivatives include acetates, butyrates, benzoates, phthalates and anthranilic acid esters of cellulose, preferably, cellulose acetate phthalate (CAP), cellulose acetate butyrate (CAB), cellulose acetate trimelitate (CAT), hydroxylpropylmethyl cellulose phthalate (HPMCP), succinoyl cellulose, cellulose fuoroate, cellulose carbanilate, and mixtures thereof.

It is preferred that the cellulose ether is selected from a group comprising a methyl cellulose, an ethyl cellulose, a hydroxyethyl cellulose, a hydroxypropyl cellulose, a methylhydroxyethyl cellulose, a methylhydroxypropyl cellulose, an ethylhydroxyethyl cellulose, a methylethylhydroxyethyl cellulose, a hydrophobically modified ethylhydroxyethylcellulose, a hydrophobically modified hydroxyethylcellulose, an alkyl cellulose, a hydroxyalkyl cellulose, a carboxyalkyl cellulose, a carboxyalkyl hydroxyalkyl cellulose and mixtures thereof.

The cellulose ether derivatives can be prepared by carboxymethylation, carboxyethylation and carboxypropylation. Examples of preferred cellulose ether derivatives are, but not limited to, nanocellulose, carboxymethyl cellulose (CMC), sodium carboxymethyl cellulose (NaCMC), hydroxypropyl cellulose (HPC), hydroxyethyl cellulose (HEC), hydroxypropylmethyl cellulose (HPMC), methyl cellulose (MC), ethyl cellulose (EC), trityl cellulose, and so on.

In some organic polymer binders, cationic cellulose derivatives may be used. Some organic polymer binders may comprise other polysaccharides such as alginates, starch, chitin and chitosan, agarose, hyaluronic acid, and their derivatives or copolymers (e.g., graft-copolymer, block copolymer, random copolymers), or mixtures thereof.

The additive employed in the present invention may be added to the build material and the organic polymer binder thereof to achieve any desired properties, such as the desired physical, mechanical and thermal properties in the slurry feedstock. In a preferred embodiment of the present invention, the additive is selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof. It is preferred that the additive is employed in an amount from about 1 vol. % to about 15 vol. %. It is understood that the amount of the additive may vary, possible outside the said range, depending upon the particular type of additive chosen in the present invention.

The plasticizer preferably means a substance added to the slurry feedstock to improve workability, flexibility and plasticity of the same. The plasticizer preferably comprises one or more organic additives including, but is not limited to, phtalates such as, dibutyl phthalate, diaryl phthalate, diethyl phthalate, dimethyl phthalate, dihexyl phthalate, di-2-methoxyethyl phthalate, triphenyl phthalate, (dipropylene glycol) butyl ether, dibutyl tartrate, diethyleneglycolmonoricinoleate, a natural or synthetic wax selected from the group comprising cetyl alcohol, stearylalcohol, cetostearylalcohol, bees wax, candellila wax, shellac wax, carnauba wax, or petroleum wax or a mixture thereof, glycerol, triethyl citrate, acetyl triethyl citrate, ethyl o-benzoylbenzoate, ethyl phthalyl ethyl glycolate, methyl phthalyl ethyl glycolate, N-Ethyltoluenesulfonamide, o-Cresyl p-toluenesulfonate, triethyl phosphate, triphenyl phosphate and any combinations thereof.

The defoaming or defoamer agent is preferably a substance that eliminates foam by reducing a surface tension of the slurry feedstock. The defoaming agent plays the role of changing the surface characteristic of the metal and the ceramic and reducing the interfacial tension of the volatile organic solvent to remove foams. The defoaming agent is preferably selected from a group comprising a polyethylene glycol, a polypropylene glycol copolymer, an alkyl poly acrylate, a poly dimethyl siloxane (silicone oil), an ethylene bis stearamide (EBS), a paraffin wax, an ester wax, a fatty alcohol wax, a white oil or vegetable oil, waxes with a long chain fatty alcohol, a fatty acid soap, an ester, a polyether modified polysilicane and a tri-alkane/alkene phosphate and mixtures thereof.

The dispersion agent is preferably a component acting for maintaining the metal and the ceramic to be mutually dispersed in the slurry feedstock. The dispersion agent is preferably a compound selected from the group consisting of silicate compounds, sodium polycarbonate, and alcohols.

The sacrificial material is preferably a material that, if present in a green or brown part prior to sintering, will not be present, at least in the same form, in any significant quantity within the fully sintered body (i.e., the final part) formed by sintering the brown part to a final article or a final part. In an embodiment, it forms a layer of material on the green or brown part where that material is later removed to leave a void. The sacrificial material may comprise aluminium orthophosphate that, as the temperature is raised during a sintering process, will initially result in the formation of a liquid phase within the green or brown part, and that will subsequently vaporize, decompose, or otherwise leave the green or brown part as one or more gaseous byproducts. The sacrificial material preferably includes a paraffin wax.

The fugitive material is preferably a material that can function as a mould for casting a ceramic part and/or a metal part within the three-dimensional structure of the article and which can then be removed from the ceramic cast part and/or the metal part by dissolving, melting and/or vaporization without harming the ceramic and/or metal cast part. The fugitive material employed in the present invention may be a rubber or plastic material that may be selected to achieve desired properties, such as thermal expansion (relative to the ceramic or metal core material) and/or its mode of being made fugitive.

In an embodiment, the sacrificial material, the fugitive material or a combination thereof is removed from the preliminary part or the preliminary part having the organic polymer binder debound therefrom (i.e., the brown part) through a thermal decomposition, a solvent debinding or any combinations thereof. It is preferred that the thermal decomposition can be selected from a group comprising heating, thermal debinding, densification/sintering, partial or complete melting of the sacrificial material and/or the fugitive material other than the build material, i.e., the metal particles and/or the ceramic particles. The said solvent debinding may involve immersion of the preliminary part, the brown part and/or the final part into a solvent which dissolves the sacrificial material and/or the fugitive material thereof. It is possible to reduce the time of debinding considerably with a better control of distortion. The said solvent includes, but not limited to, n-hexane, heptane, thinner, acetone, methylethyl ketone, carbon tetrachloride, trichloroethylene, methylene chloride, and alternative solvents, such as supercritical carbon dioxide, and water and the like.

The scaffolding material is preferably a buttressing material to add mechanical integrity to the slurry feedstock thereof. The said scaffolding material may be selected from a group comprising gel-like materials such as chitosan, fibrin, modified alginates, sturdier materials such as polycaprolactone and other plastics, and slurries containing ceramic and other powders, hydroxyapatite, or tricalcium phosphate. The scaffolding material also may include poly-caprolactone, polylactic acid, polyglycolic acid, and poly(lactide-co-glycolide).

The water-soluble inorganic salt employed in the present invention is preferably selected from a group comprising a nitrate salt, a borate salt, a chlorate salt, a perchlorate salt, a sulfate salt, a halide salt, a sodium carbonate, a potassium carbonate, a silicate salt, a phosphate salt, a salt of Group I element, an ammonium salt and combinations thereof. In an embodiment, the water-soluble inorganic salt includes a rare earth metal chloride.

The foaming or blowing agent preferably refers to a component, or a combination of components, which are capable of forming a foam, preferably a generally cellular foam structure in the slurry feedstock, particularly in the metal and/or the ceramic of the build material thereof. The foaming agent may be a solid, a liquid, or a supercritical material.

In a preferred embodiment of the present invention, the foaming agent is a heat-decomposable agent which is liquid or solid at room temperature that has a lower decomposition temperature than the melting temperature of the build material and, when heated to a temperature above the decomposition temperature, decomposes while evolving a gas such as nitrogen, carbon dioxide or ammonia. The foaming agent may be selected from a group comprising azodicarbonamide and/or metal salts thereof, hydrazodicarbonamide, sodium bicarbonate, ammonium carbonate, ammonium bicarbonate, calcium azide, trihydrazino-sym-triazine, pp′-oxybis-benzenesulfonylhydrazide, dinitrosopentamethylene tetramine, azobisisobutyl-odinitrile, toluenesulfonyl hydrazide, p-toluenesulfonyl hydrazide, benzenesulfonyl hydrazide, bisbenzenesulfonyl hydrazide, p,p′-oxybis(benzenesulfonylhydrazide), azobisisobutyronitrile, barium azodicarboxylate and combinations thereof. A polysaccharide foaming agent preferably includes an arrowroot powder, a tapioca starch, a potato starch, a wheat, a rice and a maize powder. The amount of the foaming agent can be determined according to the desired expansion factor.

The graphene as the additive employed in the present invention is preferably a polycyclic aromatic molecule formed by covalently bonding multiple carbon atoms. The covalently bonded carbon atoms form a six-member carbon ring as a repeating unit and may further include a five-member carbon ring and/or a seven-member carbon ring. In the present invention, graphene is not limited to a single layer graphene but also encompasses a multi-layer graphene having, for instance, up to 10 single graphene layers. The graphene preferably includes pure or native graphene in addition to modified graphene, such as graphene oxide or amide modified graphene.

The graphene oxide, also known as “graphitic acid” and “graphite oxide”, employed in the present invention may include a structure in which a functional group containing oxygen such as a carboxyl group, a hydroxyl group, or an epoxy group is bonded onto graphene, but may not be limited thereto, in variable ratios, and which may be obtained by treating graphite with strong oxidizers. In an embodiment of the present invention, the graphene oxide includes a nanocomposite comprising graphene oxide. The graphene oxide also includes reduced graphene oxide, which is reduced forms of graphene oxide, such as graphene oxide that has been subjected to a reduction process, thereby partially or substantially reducing it. The reduced graphene oxide also refers to graphene oxide decreased in a percentage of oxygen through a reduction process.

Other additives such as a flame retardant, a toner, a release additive, a stabilizer, an anti-static agent, an impact modifier, a colourant, an antioxidant, and a mould release agent may be used in the present invention.

The volatile organic solvent, which is chemically inert to the build material thereof, preferably evaporates or is released during or after the casting by the system of the present invention. The volatile organic solvent is required to thoroughly dissolve the components of the slurry feedstock other than the build material (e.g., the organic polymer binder), and also serve as a wetting agent. It is also desirable to use a volatile organic solvent that promotes variations of the build material (i.e., the metal and the ceramic) in composition, structure including infill pattern or any combinations thereof of the article and has a relatively high flashing point and small odour. The volatile organic solvent is preferably a solvent having a low vapour pressure of more than about 0.133 mbar or 13.3 Pa (0.1 mmHg) at about 20° C.

It is preferred that the volatile organic solvent is employed in an amount from about 1 vol. % to about 50 vol. %. In one embodiment of the present invention, an appropriate amount of the volatile organic solvent should be employed in the organic polymer binder thereof, in view of a preferred or desired concentration of the resulting solution which is the second pre-mix being the organic polymer binder solution.

The volatile organic solvent is preferably selected from a group comprising a ketone including an acetone, a butanone, a methyl ethyl ketone, a methyl amyl ketone, a methyl isobutyl ketone and a cyclohexanone, an aliphatic hydrocarbon, an aromatic hydrocarbon, an alcohol including a methanol, an ethanol, a propanol, an isopropyl alcohol and a butanol, a methyl formate, an ethylene carbonate, a propylene carbonate, a diethyl carbonate, a dimethyl carbonate, an ethyl methyl carbonate, a propylene carbonate, a 1,2-dimethoxy ethane and a γ-butyrolactone, an ethyl acetate, an isopropyl acetate, an ethyl ether, a methyl tert-butyl ether, a tetrahydrofuran, a diozane, a nitromethane, an acetonitrile, a methyl cyclohexane, an n-heptane, an n-hexane, a cyclohexane, a dipropylene glycol n-butyl ether and mixtures thereof.

In various embodiments of the present invention, the build material mixed with the additive preferably forms a first pre-mix and the organic polymer binder dissolved with or in the volatile organic solvent (i.e., the organic polymer binder solution) forms a second pre-mix. The first pre-mix and the second pre-mix are preferably mixed to form a substantially homogeneous and flowable slurry mixture that is then subjected to moulding in a cavity of the mould. Following that, the mould thereof is substantially immersed in a coagulation bath for producing a preliminary part of the said article by way of phase inversion, through which the volatile organic solvent from the same is extracted to regulate, control or manipulate a porosity or pore formed in the resulting article (i.e., the preliminary part) as minimum as possible. It is preferred that the second pre-mix is in an amount from about 10 vol. % to about 90 vol. %, more preferably from about 10 vol. % to about 70 vol. %.

The mixing thereof preferably forms or produces a substantially homogeneous and flowable slurry mixture that is subjected to the system of the present invention to produce a preliminary part of the said article. The substantially homogeneous and flowable slurry mixture of the present invention may refer to a composition to be evenly mixed having substantially one morphological phase in the same state so that at least two random samples of the composition have roughly or substantially the same amount, concentration and distribution of the components (e.g., the build material, the organic polymer binder, the additive and/or the volatile organic solvent) therein. The substantially homogeneous and flowable slurry mixture of the present invention is also meant to encompass a composition having the components (e.g., the build material, the organic polymer binder, the additive and/or the volatile organic solvent) which are flowable under gravity and/or may be pumped. Also, the substantially homogeneous and flowable slurry mixture denotes the ability of a composition to be transported by gravity or by conventional mechanical, hydraulic or pneumatic pumping means (if necessary) from a storage vessel, such as a receptacle.

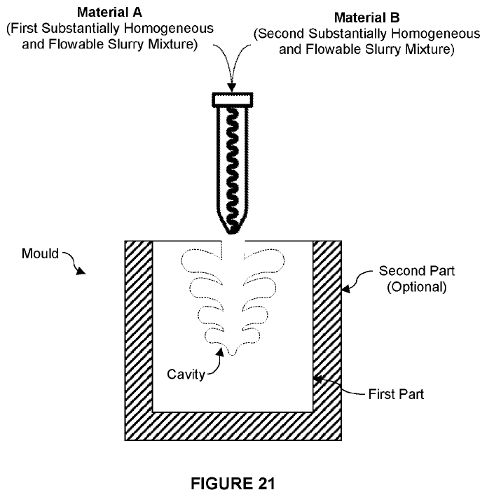

In one preferred embodiment, the substantially homogeneous and flowable slurry mixture includes two or more substantially homogeneous and flowable slurry mixtures. The two or more substantially homogeneous and flowable slurry mixtures are instantaneously mixed in situ with or without a static or active mixer to form one single substantially homogeneous and flowable slurry mixture, as schematically shown in FIGS. 20 and 21. Each of the said two or more substantially homogeneous and flowable slurry mixtures preferably comprises a respective first pre-mix and a respective second pre-mix. For instance, there are two substantially homogeneous and flowable slurry mixtures, namely a first substantially homogeneous and flowable slurry mixture and a second substantially homogeneous and flowable slurry mixture. The first substantially homogeneous and flowable slurry mixture preferably comprises a first pre-mix comprising a metal being the build material mixed with a dispersing agent being the additive, and a second pre-mix comprising a cellulose ester being the organic polymer binder dissolved in an acetone being the volatile organic solvent. The second substantially homogeneous and flowable slurry mixture preferably comprises a first pre-mix comprising a ceramic being the build material mixed with a foaming agent being the additive, and a second pre-mix comprising a cellulose ether being the organic polymer binder dissolved in a butanone being the volatile organic solvent. The resulting first and second substantially homogeneous and flowable slurry mixtures are mixed in the said single static or active mixer to form a single substantially homogeneous and flowable slurry mixture prior to being dosed into the mould.

One will appreciate that the term “in-situ” means at the site of mixing or providing the mixing, or on-site mixing. Thus, in order to form a slurry feedstock at the site of mixing, the build material, the organic polymer binder, the additive and/or the volatile organic solvent are generally co-injected (co-delivered) or otherwise applied together to a single static or active mixer (target site) therewithin and allowed to mix or assemble together at the site of co-injection within the said single static or active mixer.

One will also appreciate that the term “instantaneously” or “instantaneous” means time required for mixing the build material, the organic polymer binder, the additive, the volatile organic solvent, the build material mixed with the additive and/or the organic polymer binder dissolved with or in the volatile organic solvent (i.e., the organic polymer binder solution) to prepare the slurry feedstock thereof in the single static or active mixer thereof. In the present invention, such instantaneous mix may occur during a time interval from fractions of a second to several seconds. As compared to the total time of the process, the mixing for fractions of seconds may be considered very rapid or instantaneous.

One will further appreciate that the term “single static or active mixer” as used herein refers to a single unit of static or active mixer rather than, as in the prior art, to multiple, non-operationally linked random mixers.

In various embodiments of the present invention, the organic polymer binder is preferably debound from the preliminary part in a thermal decomposition treatment based on the said thermal decomposition temperature, a solvent debinding treatment or a combination thereof. It is preferred that the thermal decomposition treatment can be selected from a group comprising heating, thermal debinding, densification/sintering, partial or complete melting of the components other than the build material, i.e., the metal particles and/or the ceramic particles, potentially post-densification annealing to relieve or even enhance residual stresses within the preliminary part. In certain embodiments, the thermal decomposition treatment of heating may be effected at either a room temperature, or at temperatures and associated times lower than normal heat-treating times and temperatures, for example, from about 60° C. to about 200° C. for periods of about 10 minutes to about 10 hours.

The said solvent debinding treatment of the preliminary part may involve contacting the preliminary part with a solvent to extract dissolvable binders (along with additives, if any) from the body. Suitable solvents for the solvent debinding, according to the present invention, preferably includes acetone, methylethyl ketone, heptane, carbon tetrachloride, trichloroethylene, methylene chloride, and alternative solvents, such as supercritical carbon dioxide, and water.

The said thermal decomposition treatment and/or and the said solvent debinding treatment of the preliminary part, which is followed by sintering thereby, produces a final part of the article.

In accordance with one preferred embodiment of the present invention, the following may be practically used to achieve the said preliminary part (or green part):

TABLE 11
First Mixture Composition

| Mixture Composition | Vol. % |
|---|---|
| Metal | 55 |
| Cellulose acetate (200 g/L) | 35 |
| Additive (plasticiser, defoamer, dispersant) | 10 |

TABLE 12
Second Mixture Composition

| Mixture Composition | Vol. % |
|---|---|
| Alumina | 35 |
| Cellulose acetate (200 g/L) | 60 |
| Additive (plasticiser, defoamer, dispersant) | 5 |

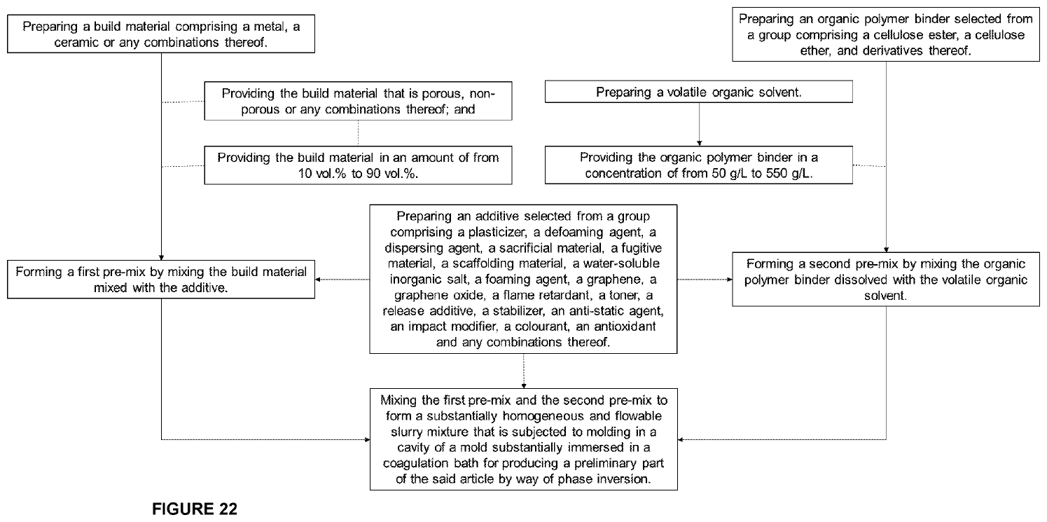

With reference to FIG. 22, the method of preparing the slurry feedstock for use in the casting of an article preferably comprises the following steps:
(a) preparing a build material comprising a metal, a ceramic or any combinations thereof, including:
   (a-1) providing the build material that is porous, non-porous or any combinations thereof; and
   (a-2) providing the build material in an amount from 10 vol. % to 90 vol. %;
(b) preparing an organic polymer binder selected from a group comprising a cellulose ester, a cellulose ether, and derivatives thereof, including:
   (b-2) providing the organic polymer binder in a concentration from 50 g/L to 550 g/L;
(c) preparing an additive selected from a group comprising a plasticizer, a defoaming agent, a dispersing agent, a sacrificial fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof;
(d) preparing a volatile organic solvent; and
(e) forming a first pre-mix by mixing the build material mixed with the additive;
(f) forming a second pre-mix by mixing the organic polymer binder dissolved with the volatile organic solvent; and
(g) mixing the first pre-mix and the second pre-mix to form a substantially homogeneous and flowable slurry mixture that is subjected to moulding in a cavity of a mould substantially immersed in a coagulation bath for producing a preliminary part of the said article by way of phase inversion, through which the volatile organic solvent from the same is extracted to regulate, control or manipulate a porosity or pore formed in the resulting article as minimum as possible.

It is preferred that the method includes the step of forming two or more substantially homogeneous and flowable slurry mixtures, each comprising a respective first pre-mix and a respective second pre-mix, and the step of instantaneously mixing the two or more substantially homogeneous and flowable slurry mixtures in situ in a static or active mixer to form one substantially homogeneous and flowable slurry mixture.

As described in the preceding paragraphs, the organic polymer binder is debound from the preliminary part in either or both the thermal decomposition treatment and the solvent debinding treatment followed by sintering to thereby produce a final part of the article containing the build material having selectively varied in composition, structure including infill pattern or any combinations thereof gradually over a volume of the final part thereof in one or more directions.

Although the method is depicted as a sequence of numbered steps for clarity, the numbering does not necessarily dictate the order of the steps. It should be understood that some of these steps may be skipped, performed in parallel, or performed without the requirement of maintaining a strict order of sequence.

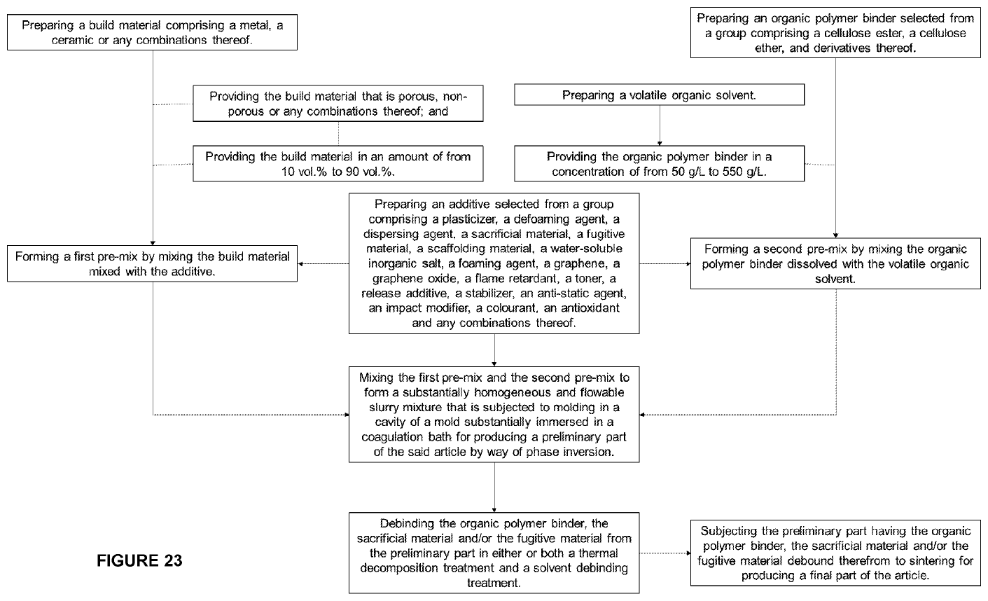

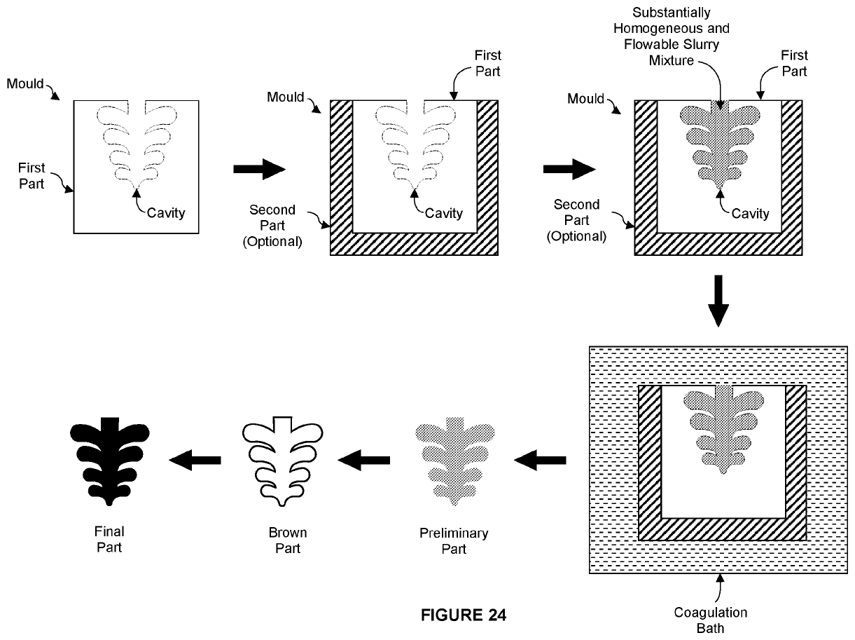

With reference to FIGS. 23 and 24 the method of casting an article preferably comprises the following steps:
(a) providing a slurry feedstock, including:
   (a-1) preparing a build material comprising a metal, a ceramic or any combinations thereof, including:
      (a-1-3) providing the build material that is porous, non-porous or any combinations thereof; and
      (a-1-4) providing the build material in an amount from 10 vol. % to 90 vol. %;
   (a-2) preparing an organic polymer binder selected from a group comprising a cellulose ester, a cellulose ether, and derivatives thereof, including:
      (a-2-2) providing the organic polymer binder in a concentration from 50 g/L to 550 g/L;
   (a-3) preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
   (a-4) preparing a volatile organic solvent;
(b) forming a first pre-mix by mixing the build material mixed with the additive;
(c) forming a second pre-mix by mixing the organic polymer binder dissolved with the volatile organic solvent;
(d) mixing the first pre-mix and the second pre-mix to form a substantially homogeneous and flowable slurry mixture;
(e) subjecting the said substantially homogeneous and flowable slurry mixture to moulding in a mould;
(f) substantially immersing the mould having a cavity filled with the substantially homogeneous and flowable slurry mixture thereof in a coagulation bath to produce a preliminary part of the said article by way of phase inversion, through which the volatile organic solvent from the same is extracted;
(g) debinding the organic polymer binder from the preliminary part in either or both a thermal decomposition treatment and a solvent debinding treatment; and
(h) subjecting the preliminary part having the organic polymer binder debound or removed therefrom (i.e., the brown part) to sintering for producing a final part of the article.

It is preferred that the method includes the step of forming two or more substantially homogeneous and flowable slurry mixtures, each comprising a respective first pre-mix and a respective second pre-mix, and the step of instantaneously mixing the two or more substantially homogeneous and flowable slurry mixtures in situ in a static or active mixer to form one substantially homogeneous and flowable slurry mixture.

Although the method is depicted as a sequence of numbered steps for clarity, the numbering does not necessarily dictate the order of the steps. It should be understood that some of these steps may be skipped, performed in parallel, or performed without the requirement of maintaining a strict order of sequence.

In one preferred embodiment of the present invention, the system employed for casting an article preferably comprises one or more receptacles, a (reusable) mould, a coagulation bath, a means for debinding and optionally, a single static or active mixer.

The one or more receptacles, or containers, tanks or vessels, are preferably configured for separately receiving a slurry feedstock and/or the components thereof as described in the preceding paragraphs. The receptacles are preferably hermetically sealed. The receptacle may be made of metal, plastic and the like, or a composite thereof, of various shapes and sizes.

In an embodiment, each of the receptacles receives the build material, the organic polymer binder, the additive and the volatile organic solvent in a separate, individual manner. For instance, there are four separate receptacles, each of which is adapted to store the build material, the organic polymer binder, the additive and the volatile organic solvent. These four receptacles are specially configured for the in situ mixings of the said components of the slurry feedstock.

In another embodiment, the metal and the ceramic of the build material are contained in different separate receptacles. For example, the metal particles are stored in the first receptacle and the ceramic particles in the second receptacle. The metal and the ceramic of the build material can be further stored in many separate receptacles, depending on, for instance, the properties of the particular metals or ceramics (e.g., physical properties, chemical properties, rheological properties, etc.), the types of the metal and/or ceramic (e.g., metal A, metal B, ceramic A, ceramic B, porous metal A, porous metal B, porous ceramic A, porous ceramic B, etc.), and the required final properties of the article thereof. In another embodiment of the present invention, the build material can be mixed with the additive forming a first pre-mix and stored in one receptacle, and the organic polymer binder can be dissolved with or in the volatile organic solvent forming a second pre-mixed and stored in another receptacle; these two receptacles are configured for providing such mixtures (i.e., the premixed build material and additive and the pre-dissolved organic polymer binder in the volatile organic solvent) to the said static or active mixer.

In yet another embodiment, a first receptacle is configured to store the slurry feedstock which is the substantially homogeneous and flowable slurry mixture containing the build material mixed with one additive and the organic polymer binder solution, and a second receptacle is configured to store another additive mixed with the organic polymer binder solution. The said first receptacle and the said second receptacle are preferably arranged for varying a micro porosity of the article to achieve any desired or targeted infill pattern. In this regard, the said another additive is the sacrificial material and/or the fugitive material. The aforementioned arrangement of receptacles may not be applicable for macro porosity variation.

The mould, which is reusable, is essentially configured for moulding the said substantially homogeneous and flowable slurry mixture received or dosed from the one or more receptacles thereof in its cavity. The cavity is preferably used to obtain an article with the desired shape. It is preferred that the cavity is formed concentrically, internally and centrally within the body of the mould thereof. In one embodiment, the mould has an effectively continuous mould wall or casting surface of any desired shape that encircles or circumscribes the cavity. The said cavity may have any shape including a regular or irregular polygonal shape, for instance, a bell shape, a pyramid trunk shape, and a spherical segment shape of two bases.

The shape of the mould wall is often rectangular or square but may be round or any other symmetrical or even non-symmetrical shape to produce articles of corresponding cross-sectional shapes. If desired, the encircling mould wall may be adjustable in length and/or shape, e.g., by providing end walls that are slidable between a pair of parallel side walls to vary the cross-sectional area and shape of the cavity defined by the walls. In such an arrangement, although the end walls may not be integral with the side walls, the walls fit together closely so that the combined mould wall made up of the end walls and side walls is effectively continuous and avoids molten metal leakage.

In one preferred embodiment, the mould comprises a first part in which the cavity is recessed or formed. The first part of the mould thereof may be defined by two-part sections having surfaces facing each other and joining along a central parting plane to form a single component of the first part. The two-part sections preferably include a female part section and a male part section that can be seamlessly joined or mated and held in a position with or without a locking means such as pins and latches. The two-part sections of the first part thereof can dismantled or demountable for demoulding or removing the preliminary part resulting thereof from the said cavity.

It is preferred that the first part of the mould is fabricated of or from a material selected from a group comprising silicone, ceramic, concrete, thermoplastic, ultraviolet-curable resin including high-density polyethylene, medium-density polyethylene, low-density polyethylene, crosslinked polyethylene, polytetrafluoroethylene, polyethylene terephthalate, and polypropylene, polycarbonate, polylactide, epoxy resin, acrylonitrile butadiene, styrene, fiberglass, nylon, and any combinations thereof. Other materials non-dissolvable by ketone and alcohol solvent can also be used in the present invention. In one embodiment, the first part of the mould is obtained, produced or prepared by way of additive manufacturing or three-dimensional (3D) printing.

The first part of the mould may be permeable or non-permeable. In the case of permeable, the first part may have a peripheral wall with a permeable wall portion. With the term permeable is used herein, the entire peripheral wall of the first part does not necessarily have to be permeable, but instead only that portion through which gas flow is desired. The said permeable wall portion can be made of ceramic, silicone (due to characteristic of material), or microstructure printed on the mould, which is an engineering design structure. The permeable first part is essentially configured to allow the phase changes to take place between the solvent in the slurry mixture thereof with the non-solvent particles in the coagulation bath, resulting in controllable pores forming in the article during the drying process.

The mould of the present invention may further comprise a second part. The second part, which is preferably a single piece, is configured for removably enveloping the said first part. The said second part may be a tubular or elongated sleeve slidably engageable with the outer wall of the first part such that the first part is insertable thereinto in a snuggly fitting manner. The second part may envelop or cover a portion or substantially the entire first part. The second part may or may not be a liquid-proof and/or liquid resistant structure to the first part. In one embodiment, the second part of the mould may allow a certain liquid, for instance those from the coagulation bath, to enter and contact upon the first part and/or the substantially homogeneous and flowable slurry mixture dosed in the cavity thereof to initiate the phase inversion.

The said second part may be fabricated from the same material as the first part. In one embodiment, the second part is obtained, produced or prepared by way of additive manufacturing or 3D printing. A solid silicone may be applied to the second part of the mould so as to increase, enhance or improve the strength and structural integrity of the second part.

The second part of the mould may be permeable or non-permeable. In the case of permeable, the second part may have a peripheral wall with a permeable wall portion. With the term permeable is used herein, the entire peripheral wall of the second part does not necessarily have to be permeable, but instead only that portion through which gas flow is desired. The said permeable wall portion can be made of ceramic, silicone (due to characteristic of material), or microstructure printed on the mould, which is an engineering design structure. The permeable second part is essentially configured to allow the phase changes to take place between the solvent in the slurry mixture thereof with the non-solvent particles in the coagulation bath, resulting in controllable pores forming in the article during the drying process.

In one preferred embodiment of the present invention, the first part of the mould can be prepared through a silicone mould-making process where a physical article to be cast is employed to form a negative silicone mould. The silicone mould is cast and subjected to a washing process using a permeable silicone formulation (i.e., a mixture of room-temperature-vulcanizing (RTV) silicone/platinum cured silicone with fine salt whose grain size is within 5-10 μm) to form a permeable silicone mould with a pore size of 5-10 μm. This allows the phase inversion to take place between the cast slurry mixture and the non-solvent. The second part of the mould, which is the external permeable mould, can be coated with a solid silicone wall to enhance the mould rigidity and prolong the reusability.

In another preferred embodiment of the present invention, the mould can be made using a 3D printing process via the fuse deposition method (FDM) using various thermoplastics, e.g., HDPE, LDPE, PETG, PP, PC, or thermoplastic which is non-dissolvable by ketone & alcohol solvent, or stereolithography (SLA) using a UV-based resin which is resisted to ketone group or direct ink writing process of using the permeable silicone formulation to form the permeable mould. For FDM and SLA method, the permeable mould is achieved by being embedded in a microchannel into a mould design and realized using the 3D printing.

According to an embodiment of the present invention, in the manufacture of an article according to the present invention, this is cast from at least two different substantially homogeneous and flowable slurry mixtures of different material compositions (e.g., Material A and Material B of FIGS. 2 and 3) into one united piece. The at least two different substantially homogeneous and flowable slurry mixtures are supplied into the mould where they are allowed or caused to harden into a casting whose form is defined by the form of the cavity which is enclosed in the mould. The casting operation may be put into effect such that a clear and sharp interface between the different substantially homogeneous and flowable slurry mixtures is achieved, or alternatively the casting operation may be put into effect so that a certain intermingling of the two different substantially homogeneous and flowable slurry mixtures takes place in an interface zone.

In the casting operation so that a sharply defined interface occurs, the first cast part of the article is allowed to harden so far that no intermingling of the substantially homogeneous and flowable slurry mixtures occurs.

In the casting so that an interface zone is formed between the cast parts of the article, the hardening and cooling of the first cast part is allowed to continue only so far that a limited intermingling of the substantially homogeneous and flowable slurry mixtures can take place or that a certain dissolution, softening or any other alterations alike of the already cast part can take place. The positive cooling or rest cooling of the substantially homogeneous and flowable slurry mixture which was cast first may also be put into effect in a directed fashion, so that a hardening zone migrates through the casting and finally arrives at that side of the cast part where the additional casting-on is to take place.

The coagulation bath is preferably configured for substantially immersing the mould filled with the substantially homogeneous and flowable slurry mixture therein for a period of time (e.g., 6, 12 and 24 hours) to produce a preliminary part of the said article by way of phase inversion. During the phase inversion, the volatile organic solvent in the said substantially homogeneous and flowable slurry mixture is preferably extracted to regulate, control or manipulate a porosity or pore formed in the resulting article (i.e., the preliminary part) as minimum as possible. By controlling the cellulose binder concentration and volume mixture between the binder and the build material, i.e., the metal/ceramic powder content, porous and/or non-porous articles can be cast, which is not feasible by the conventional casting methods.

The coagulation bath, in which the phase inversion of the slurry feedstock stored in the cavity of the mould takes place, is preferably a non-solvent liquid (or coagulating liquid). The said non-solvent liquid can be selected from a group comprising water, distilled water, pure water and any combinations thereof. Other liquids non-solvent to the organic polymer binder can also be used in the present invention. The said coagulation bath is preferably rendered in a container suitable for receiving and submerging the said mould therein. In one embodiment, the container storing the said coagulation bath may receive and cater for one or more moulds at the same time. The container may have a holding frame removably attached within the said container. The holding frame, with a suitable locking member, is preferably configured to secure or hold the said mould(s) in a designated position within the coagulation bath. The holding frame may further comprise an adjustable mounting such that the said frame can be elevated above the coagulation bath for retrieving the mould, levelled with the container floor for immersing the mould, and so forth.

The means for debinding is preferably a post-treatment unit referring to a mechanism to debind or remove the organic polymer binder from the preliminary part retrieved from the mould thereof. In one preferred embodiment, the means for debinding comprises either or both a thermal decomposition treatment unit for performing a thermal decomposition treatment and a solvent debinding treatment unit for performing a solvent debinding treatment followed by sintering to thereby produce a final part of the article. The means for debinding may also include a sintering treatment unit.

The single static or active mixer, optionally employed in the present invention, is preferably configured for singularly, instantaneously mixing two or more substantially homogeneous and flowable slurry mixtures in situ to form one or single substantially homogeneous and flowable slurry mixture prior to transfer to the mould.

The static or motionless mixer is essentially a mixer that does not include internal moving mechanical parts. The static mixer is preferably a device that includes one or more substantially stationary mixing elements, e.g., baffles such as blades, plates, vanes, that are adapted for placement in the path of a flowing fluid, e.g., the slurry feedstock and/or its components thereof through a conduit, to produce a pattern of flow divisions and splits to accomplish mixing, e.g., radial mixing via radial circulation or exchange, in the flowing fluid. Although the stationary mixing elements are typically immovable within the conduit, some limited movement of the stationary elements relative to the conduit can occur so long as such limited movement does not contribute substantially to the mixing of the flowing fluid. In a static mixer having multiple stationary elements, these elements can be arranged in series and/or in a staggered orientation relative to one another. The static mixer is preferably selected to generate a mixed flowing stream, i.e., the substantially homogeneous and flowable slurry mixture, over a short length of the mixer. The active mixer, on the other hand, is preferably opposite of the said static mixer and it comprises moving parts. The active mixer may blend the slurry feedstock and its components thereof together after they have been or while been loaded thereto. Other mixers of similar characters could likely be used instead of the aforementioned mixer as can be appropriately selected by one skilled in the art.

In one representative embodiment, the slurry feedstock of the present invention relies on the evaporation of the solvent-based binder to form a cured article or object. Therefore, the control of the organic polymer binder's concentration and the ratio between the said binder and the binding particles (i.e., the metal and/or ceramics powders) become a crucial step to ensure the cast article has a sufficient static yield stress to sustain its shape once dosed or deposited in the mould.

In order to have an effective homogenous mixture, the slurry mixture has to be prepared such that both types of material raw stocks have a slight variation of viscosity changes across a range of shear rates. As different types of powder sizes or shapes would yield significant differences in terms of their rheological behaviours. The tuning of rheology must be performed within each material and the combination of both mixtures across all the variation mixtures. Ideally, they should be within the range of about 30-90 vol. % for the metal and/or the ceramic, about 50-500 g/L and/or 2.5-70 vol. % for the organic polymer binder and about 1-15 vol. % for the additive(s). An effective mixture that can vary across a large range of ratio between two materials and it is not achievable by simply mixing any two materials together. For example, to obtain a flowable mixture suitable for casting a ratio of about 10-80 vol. %, it may require feedstock material A to be very viscous and material B to be very liquid in its raw state. As both slurries are non-Newtonian fluid in nature, therefore a similar shear rate or pumping rate may yield a different volumetric flow rate which results in the inaccuracy of mixture ratio as programmed by the user. Thus, in the present invention, the rheology profiles of the feedstock materials (i.e., the components of the slurry feedstock) and their mixtures must be attained and mapped through the experimental setup. These rheology profiles will be integrated with the design of the material profiles to form a unique compensation factor to be included during the post-processing of the slicer Gcode to ensure feeding volumetric flow rates of both the slurries are consistent such that a uniform mixture ratio is attainable. There is an effective mixture ratio achievable between two materials, i.e., usually in a range of about 10-90%. This allows the creation of a metal and ceramic mixture, i.e., metal A and metal B, metal A (porous mixture) and metal A (non-porous mixture), ceramic A (porous) and ceramic A (non-porous) or ceramic A and ceramic B formation depending on the need and properties of the article needed to be formed. The mixture of the material that flows through the mixer can be more than two types of materials and is not limited to that shown in any figures. This setup enables material A and material B to be mixed in a precise ratio during the casting process.

Examples of the setup are provided below:
Material A (metal/ceramic A with low concentration binder in liquid form) and material B (pure binder with additive premix).
Material A (porous metal/ceramic mixture) is formulated through the addition of scaffolding non-soluble material/foaming agents with Material A (concentrated mixture), wherein Material A can be selected from a group of metal and ceramic. This allows the casting of unique structures such as the shell can be solid and infill with porous materials (see FIG. 4).

The following provides non-limiting combinations of the build material, which comprises the metal and the ceramic:
Metal-Metal
   (i) Al—Cu
   (ii) AL-Ni
   (iii) Ni—Ti
   (iv) 316L-H13
   (v) Ti-6Al-4V-304L
   (vi) Low carbon steel-high carbon steel
   (vii) 304-304 porous structure
Metal-Ceramic
   (i) Al—SiC
   (ii) Al—Al₂O₃
   (iii) Ni—ZrO₂
   (iv) Cu—SiC
Ceramic-Ceramic
   (i) SiC—SiC (different density)
   (ii) Al₂O₃—Al₂O₃ (porous structure)
   (iii) Al₂O₃—SiC
   (iv) Al₂O₃— ZrO₂

For transition between low carbon steel-high carbon steel, the following composition may be used:

TABLE 13
First Mixture Composition

| Mixture Composition | Vol. % |
|---|---|
| Fe90Cu10 | 35 |
| Cellulose acetate (100 g/L) | 59 |
| Additive (plasticiser, defoamer, dispersant) | 6 |

TABLE 14
Second Mixture Composition

| Mixture Composition | Vol. % |
|---|---|
| Fe89Cu10C1 | 35 |
| Cellulose acetate (100 g/L) | 59 |
| Additive (plasticiser, defoamer, dispersant) | 6 |

For a 304-304 porous structure, the porosity of the structure is controlled by the size of the crystallization of the salts. The following may be used:

TABLE 15
First Mixture Composition

| Mixture Composition | Vol. % |
|---|---|
| 304 | 35 |
| Cellulose butyrate (100 g/L) | 57 |
| Additive (plasticiser, defoamer, dispersant) | 6 |
| Triphenyl phosphate | 2 |

TABLE 16
Second Mixture Composition

| Mixture Composition | Vol. % |
|---|---|
| Cellulose butyrate (100 g/L) | 55 |
| Additive (plasticiser, defoamer, dispersant) | 5 |
| Sodium nitrate | 40 |

For a transition between clay and low carbon steel, the following may be used:

TABLE 17
First Mixture Composition

| Mixture Composition | Vol. % |
|---|---|
| Metal | 65 |
| Cellulose acetate (200 g/L) | 25 |
| Additive (plasticiser, defoamer, dispersant) | 10 |

TABLE 18
Second Mixture Composition

| Mixture Composition | Vol. % |
|---|---|
| Low carbon steel | 40 |
| Cellulose acetate (200 g/L) | 55 |
| Additive (plasticiser, defoamer, dispersant) | 5 |

### Yet Further Embodiments/Aspects

A newly invented 3D printing system using a unique composition of metal and/or ceramic powder-binder slurry mixture is introduced as feedstock material. The binder used in the metal and/or ceramic mixture is comprised of an organic polymer binder from the group of cellulose esters, cellulose ethers and its derivatives. It is dissolved in organic solvents as the base binder in 10-70 vol % to bind the solid particles consisting of one or more metal and/or ceramic powder in 30-90 vol % with additives (dispersant, rheology modifier, defoamers, or foam agents) to form a metal and/or ceramic powder-binder slurry mixture.

In an embodiment of the invention, the term build material relates to a solid particle material or a powder of the material. The material will be mixed as part of the preparation for the feedstock material. The solid particle size can range from 0.1 to 100 μm. The material refers to at least one metal and/or ceramic or mixture of more than one type of build material used in the preparation of “feedstock” or “slurry mixture” and may be used interchangeably. The binder in the present context is referring to the cellulose group of ester, ethers and derivatives only.

In the present context, a cellulose derivative of ether and ester group thereof is to be understood as one of the bio-based polymers with a functional group of ether and ester connected to its main molecular chain.

Cellulose ethers are high molecular weight compounds produced by replacing the hydrogen atoms of hydroxyl groups in the anhydroglucose units of cellulose with R which belongs to alkyl or substituted alkyl groups. Examples of cellulose ethers include methyl cellulose and ethyl cellulose.

Cellulose esters are generally water insoluble polymers with good film forming characteristics, which is categorized in organic and inorganic groups. Various types of organic cellulose esters can be used such as cellulose acetate (CA), cellulose acetate phthalate (CAP), cellulose acetate propionate, cellulose acetate butyrate (CAB), cellulose acetate trimelitate (CAT), hydroxupropylmethyl cellulose phthalate (HPMCP), etc. Inorganic cellulose esters that can be used are cellulose nitrate and cellulose sulphate.

In a preferred embodiment, the molecular weight of the binder is less than Mw˜100,000. The slurry mixture is prepared by first dissolving the binder in the concentration range of 20-70 g per 100 ml of solvent (i.e., with purity ≥95%).

The base binder can be a single type binder of the group or mixture of different molecular weight between similar or mixture of more than one type group of binder or blending of different molecular weight of the similar group binder as the based binder formulation. The mixture of the different molecular weight or different type of binder group is possible to achieve the desired rheology and curing control. Similarly for the solvent selected for dissolving the binder can be a single type or mixture of different solvent, depending on the mixture composition in the base binder formulation.

The solvent used to dissolve the binder is preferably of volatile organic solvent solution depending on the mixture composition in the base binder formulation. Preferred use of volatile organic solvent includes ketones and esters.

Ketones refer to any of a class of organic compounds characterized by the presence of a carbonyl group in which the carbon atom is covalently bonded to an oxygen atom. The remaining two bonds are to other carbon atoms or hydrocarbon radicals (R). Examples of ketones include acetone, cyclohexanone, diacetone alcohol and etc.

Esters have general formula RCOOR′, where R may be a hydrogen atom, an alkyl group, or an aryl group, and R′ may be an alkyl group or an aryl group but not a hydrogen atom. If it is hydrogen atom, the compound would be a carboxylic acid. Examples of esters include methyl formate, ethyl lactate and etc.

Others suitable organic solvents are nitromethane, acetonitrile, methyl glycol, tetrahydrofuran, alcohol, ether, aromatic solvent, aliphatic solvent and diaoxane.

Additives such as plasticizer, anti-foaming agents or foaming agents could be added to the formulation to obtain desired rheological behaviour and printing characteristic. Foaming agent allows the user to control the density of the printed object through mixing to form the desired porosity during the printing process. Through in-situ addition and mixing of a foaming agent, the porosity of the metal parts can also be controlled during the printing process. The same method can be applied to control the binder viscosity, green part binder strength, structural and mechanical characteristics and curing speed during the printing process. Solid particles, in this case metal and/or ceramic powder can be prepared by wetting and dispersing additive premixed with base binder solution to form a slurry mixture. The mixture is prepared under a controlled environment, i.e., with vacuum and/or inert gas condition.

Phthalates plasticizers appear colourless with a faint odour and limited solubility in water but are miscible in various organic solvents. Phthalates are produced by esterification of phtalic anhydride obtained by the oxidation of orthoxylene.

Phthalate has a basic structure of a benzene dicarboxylic acid with two side chains (R and R′) which can be alkyl, benzyl, phenyl, cycloalkyl, or alkoxy groups. The defining characteristics of each phthalate and its decomposition pattern are determined by the length of the dialkyl side chain. If a phthalate is more branched, then it has more isomers available and probably hydrophobic. Examples of phthalate plasticizers include dibutyl phthalate, diaryl phthalate, diethyl phthalate, dimethyl phthalate, di-2-methoxyethyl phthalate.

The plasticizer may be present in an amount of 2-10 wt % based on the total weight of the binder composition. In addition to the formulas of plasticizers identified above, specific examples of plasticizer may be selected from the group consisting of N-ethyltoluenesulfonamide, o-cresyl p-toluenesulfonate, dibutyl tartrate, acetyl triethyl citrate, triethyl citrate, glycerol, ethyl o-benzoylbenzoate, ethyl phthalyl ethyl glycolate, methyl phthalyl ethyl glycolate etc.

Herein, plasticizer refers to a component that increases the plasticity or fluidity of a material. In some aspects, a component may be introduced as an organic solvent but as the organic solvent is evaporated, it begins to function as a plasticizer. The binder composition comprises a plasticizer and at least one organic solvent, thus, if an organic solvent begins to function as plasticizer, the binder composition also contains a plasticizer. In other words, cellulose acetate is plasticized in the solution. In some aspects, the plasticizer may be the same as the one of the least organic solvent. In other aspect, the plasticizer is different from any of the organic solvents.

Defoamer or dispersing agent, also referred to as surfactant, such as aryl or alkyl phosphate, can be added as additive to promote suspension of solid or liquid particles in a liquid (e.g., colloid or emulsion) to improve separation of the particles and to prevent settling or clumping. Other examples of dispersing agents are triethyl phosphate and triphenyl phosphate.

The present embodiment of solid particle in the form of metallic material refers to the group consisting of one or a combination of more than one of the following elements:
Stainless steel: 17-4PH, 304, 304L, 310, 316, 316L, 420, 440, 430L etc.
Titanium & titanium alloy: Ti64, Ti-6Al-4V, Ti64ELI etc.
Aluminium & aluminium alloy: AlSi10Mg, AlSi7Mg, ADC12, AlMg5Mn etc.
Nickel & Nickel alloy: 718, 625, Hastelloy@ X, Kovar, Invar 36, Hastelloy® C etc.
Other metals: A2, D2, H13, M2, 4140, CoCr, CoCrMo, copper alloy, bronze, magnesium, carbon steel, chromoly steel, Fe-3% Si, Fe-50% Ni, Fe-50% Co, W, WC-5Co, WC-1-Co etc.

The present embodiment of solid particle in the form of ceramic material refers to the group consisting of one or a combination of more than one of the following elements:
Calcium phosphate ceramics: Hydroxyapatite (HAp), tricalcium phosphate (TCP), amorphous calcium phosphates (ACPs) and biphasic calcium phosphates (BCPs)
Oxide ceramics: Aluminium oxide, beryllium oxide, zirconium dioxide, yttria stabilized zirconia (YSZ)
Silicate ceramics: Porcelain, aluminium silicates, kaolin, magnesium silicates, mullite
Carbide ceramics: Boron carbide, silicon carbide, tungsten carbide
Nitride ceramics: silicon nitride, silicon aluminium oxynitride, aluminium nitride and mixtures thereof
The particle mesh size is preferably less than 200.
Now, the use of the feedstock material is described.

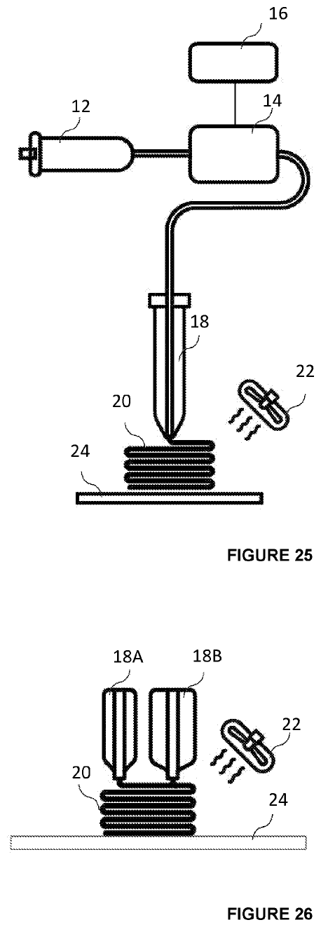

The feedstock is placed in a sealed storage tank 12, ready to be fed into an extrusion-based 3D printer which can dispense the slurry mixture, layer by layer, as shown in FIG. 25, to form a 3D object. The storage tank 12 is 15 pressurized to transport the feedstock into a pump 14 which can be a progressive cavity pump, peristaltic pump or syringe driven by a printer controller 16. A nozzle 18 moves and dispenses feedstock material to form a green part 20.

The green part 20 can be cured under room temperature or with added ventilation 22. The green part 20 can be printed on an optional hot plate 24. A heated chamber of 30-100 0 C can also aid the curing process. The printed green part 20 has sufficient holding strength for easy handling.

The printer can be setup with more than one type of slurry metal and/or ceramic mixture sent through separate nozzles 18A, 18B, as shown in FIG. 26, to form a unique multi-material or discrete continuous graded material structure upon post-processing.

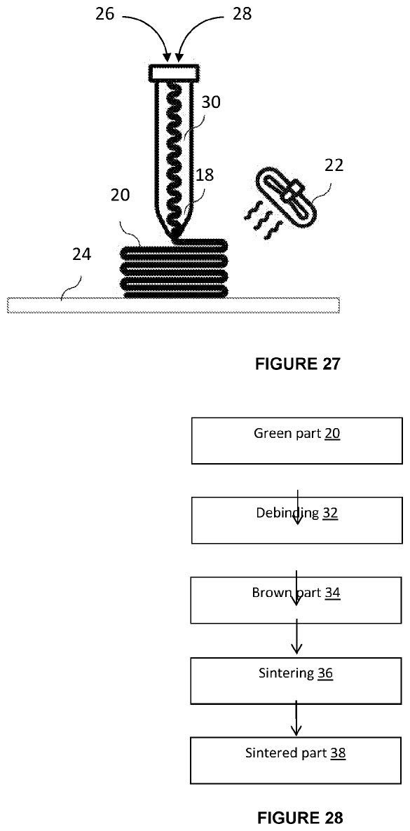

Another setup for slurry mixture-based printing can be performed through in-situ mixing, as shown in FIG. 27. A first supply 26 and a second supply 28 are delivered prior to mixing in a mixer 30 with the following setup:

### First Setup:

First supply—binder solution
Second supply—metal and/or ceramic powder solution
   Second setup:
First supply—metal-binder slurry mixture
Second supply—ceramic-binder slurry mixture

Two supplies 26, 28 are fed into the mixer 30 during the printing process. Post curing of green part 20 may be required depending on its size to ensure a fully cured structure before proceeding to post-processing steps.

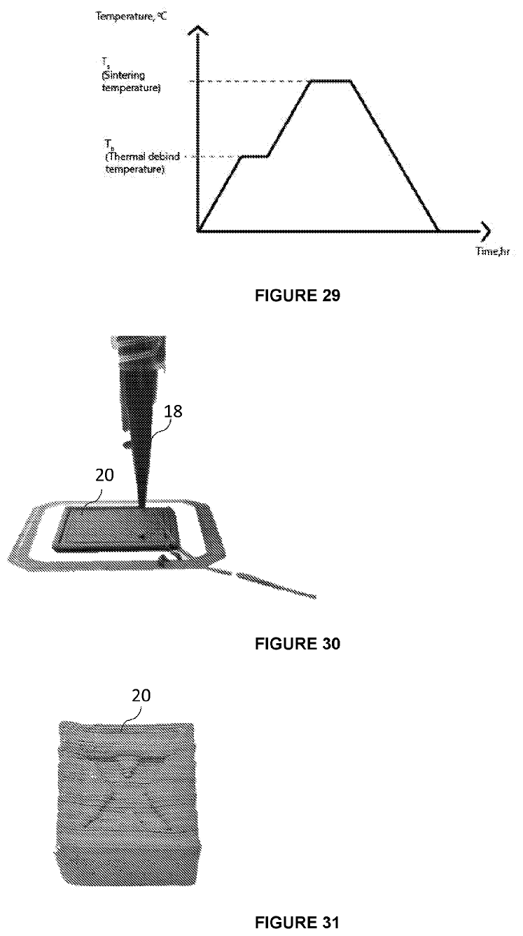

Post-processing of the printed object includes debinding 32, to form a brown part 34, and sintering 36 to form a final sintered part 38. The thermal debinding 32 and sintering process 36 can be carried out in a single heating process or two distinctive processes under a controlled environment based on the type of metal and/or ceramic particle following a specific temperature profile for the type of material to be processed. A thermal debinding and sintering profile is shown in FIG. 29. During thermal debinding, the green part will be heated to a binder thermal decomposition temperature and the holding time can be varied accordingly to the part size to ensure the binder is thoroughly removed. It is followed with the sintering process to fuse the metal and/or ceramic particle at the specific temperature for the type of material to be processed. Additional post processing treatment such as heat treatment, surface finishing or machining may be added.

### Example 1

A stainless steel 17-4PH is prepared with 60% vol 17-4PH metal powder with an average particle size of 15 μm and 40% vol binder solution. A binder cellulose acetate solution is prepared with 40 g per 100 ml solvent of acetone.

Within the binder solution, there is 10% vol of additives consisting of a mixture of plasticizer, defoamer and dispersing agent.

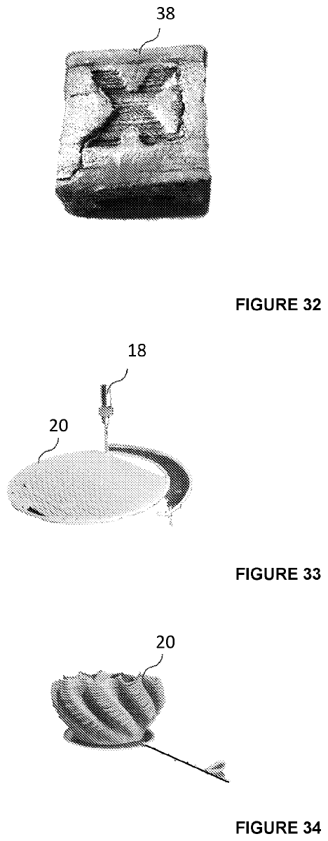

A basic printing setup in a non-heated environment is shown in FIG. 30. The setup provided a green part 20, as shown in FIG. 31. After post-processing, a sintered stainless steel 38 is obtained, as shown in FIG. 32.

### Example 2

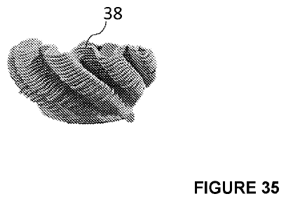

A mixture of ceramic is prepared with kaolin 70% vol and binder solution 30% vol. Cellulose acetate of 40 g is prepared in 100 ml of solvent acetone. A basic printing setup in a non-heated environment is shown in FIG. 33. The setup provided a green part 20, as shown in FIG. 34. After post processing, a sintered ceramic 38 is obtained, as shown in FIG. 35.

Accordingly, a feedstock for 3D printing is introduced. The feedstock is made of metal and/or ceramic slurry mixture. The feedstock can be directly printed to obtain an intended 3D object.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A slurry feedstock for extrusion-based three-dimensional, 3D, printing of a functionally graded article, characterised in that, the slurry feedstock comprising:
a build material comprising a metal, a ceramic or any combinations thereof,
wherein the build material is porous, non-porous or any combinations thereof,
wherein the build material is in an amount from 10 vol. % to 90 vol. %;
an organic polymer binder selected from a group comprising a cellulose ester, a cellulose ether, and derivatives thereof,
wherein the organic polymer binder is in a concentration from 150 g/L to 550 g/L;
an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
a volatile organic solvent,
wherein the build material mixed with the additive and the organic polymer binder dissolved with the volatile organic solvent form a first pre-mix and a second pre-mix, respectively, that are mixed to form a substantially homogeneous and flowable slurry mixture that is printed as a preliminary part of the said functionally graded article,
wherein the organic polymer binder is debound from the preliminary part in either or both a thermal decomposition treatment and a solvent debinding treatment followed by sintering to thereby produce a final part of the functionally graded article containing the build material having selectively varied in composition, structure including infill pattern or any combinations thereof gradually over volume of the final part thereof in one or more directions.

2. The slurry feedstock according to claim 1, wherein the metal is selected from a group comprising a ferrous metal, a non-ferrous metal, a ferrous metal alloy, and a non-ferrous metal alloy.

3. The slurry feedstock according to claim 1, wherein the ceramic is selected from a group comprising a silicate ceramic including clay, cordierite ceramics, steatite, stoneware, earthenware, porcelain, kaolin, quartz, silica, chamotte, bentonite, mullite, an oxide ceramic including alumina, zirconia including zirconia stabilized in yttria, Y₃O₂, beryllium oxide, yttrium oxide, titanium oxide, magnesium oxide, calcium oxide, barium oxide, zinc oxide, uranium oxide, UO₂, plutonium dioxide, PuO₂, yttrium barium copper oxide, spinel, magnetoplumbite, perovskite, tialite, a non-oxide ceramic including carbide ceramic including titanium carbide, boron carbide, tungsten carbide, silicon carbide, nitride ceramics including silicon nitride, boron nitride, aluminium nitride, aluminium oxynitride, SiAlON, a bioceramic including calcium phosphate ceramic including hydroxyapatite, HAP, tricalcium phosphate, TCP, amorphous calcium phosphate, ACP, octacalcium phosphate, OCP, dicalcium phosphate anhydrous, DCPA, dicalcium phosphate dihydrate, DCPD, tetracalcium phosphate monoxide, TetCp, biphasic calcium phosphate, BCP and any combinations thereof.

4. The slurry feedstock according to claim 1, wherein the build material comprises a particle size of not more than 300 μm.

5. The slurry feedstock according to claim 1, wherein the cellulose ester is selected from a group comprising a cellulose acetate, a cellulose acetate phthalate, a cellulose diacetate, a cellulose triacetate, a cellulose acetate butyrate, a cellulose butyrate, a cellulose tributyrate, a cellulose acetate propionate, a cellulose propionate, a cellulose tripropionate, a cellulose nitrate, a cellulose acetate propionate, a carboxymethyl cellulose acetate, a carboxymethyl cellulose acetate propionate, a carboxymethyl cellulose acetate butyrate, a cellulose acetate butyrate succinate, a cellulose propionate butyrate, and mixtures thereof.

6. The slurry feedstock according to claim 1, wherein the cellulose ether is selected from a group comprising a methyl cellulose, an ethyl cellulose, a hydroxyethyl cellulose, a hydroxypropyl cellulose, a methylhydroxyethyl cellulose, a methylhydroxypropyl cellulose, an ethylhydroxyethyl cellulose, a methylethylhydroxyethyl cellulose, a hydrophobically modified ethylhydroxyethyl cellulose, a hydrophobically modified hydroxyethyl cellulose, an alkyl cellulose, a hydroxyalkyl cellulose, a carboxyalkyl cellulose, a carboxyalkyl hydroxyalkyl cellulose and mixtures thereof.

7. The slurry feedstock according to claim 1, wherein the organic polymer binder comprises a number average molecular weight of not more than 150,000.

8. The slurry feedstock according to claim 1, wherein the volatile organic solvent is selected from a group comprising a ketone including an acetone, a butanone, a methyl ethyl ketone, a methyl amyl ketone, a methyl isobutyl ketone and a cyclohexanone, an aliphatic hydrocarbon, an aromatic hydrocarbon, an alcohol including a methanol, an ethanol, a propanol, an isopropyl alcohol and a butanol, a methyl formate, an ethylene carbonate, a propylene carbonate, a diethyl carbonate, a dimethyl carbonate, an ethyl methyl carbonate, a propylene carbonate, a 1,2-dimethoxy ethane and a γ-butyrolactone, an ethyl acetate, an isopropyl acetate, an ethyl ether, a methyl tert-butyl ether, a tetrahydrofuran, a diozane, a nitromethane, an acetonitrile, a methyl cyclohexane, an n-heptane, an n-hexane, a cyclohexane, a dipropylene glycol n-butyl ether and mixtures thereof.

9. The slurry feedstock according to claim 1, wherein the substantially homogeneous and flowable slurry mixture includes two or more substantially homogeneous and flowable slurry mixtures, each comprising a respective first pre-mix and a respective second pre-mix.

10. The slurry feedstock according to claim 9, wherein the two or more substantially homogeneous and flowable slurry mixtures are instantaneously mixed in situ in a static or active mixer to form one substantially homogeneous and flowable slurry mixture.

11. The slurry feedstock according to claim 1 or 9, wherein the second pre-mix is in an amount from 10 vol. % to 90 vol. %.

12. The slurry feedstock according to claim 1 further comprises a support material forming a substantially homogeneous and flowable support mixture configured for printing a support structure for an overhanging or cantilevered portion of the said functionally graded article.

13. The slurry feedstock according to claim 12, wherein the said support material comprises a ceramic, a sacrificial material, a fugitive material or any combinations thereof.

14. The slurry feedstock according to claim 1 or 13, wherein the sacrificial material is debound from the preliminary part in either or both a thermal decomposition treatment and a solvent debinding treatment.

15. The slurry feedstock according to claim 1 or 13, wherein the fugitive material is debound from the preliminary part in either or both a thermal decomposition treatment and a solvent debinding treatment.

16. A method of preparing a slurry feedstock for extrusion-based three-dimensional, 3D, printing a functionally graded article, characterised in that, the method comprising the steps:
preparing a build material comprising a metal, a ceramic or any combinations thereof, including:
providing the build material that is porous, non-porous or any combinations thereof; and
providing the build material in an amount from 10 vol. % to 90 vol. %;
preparing an organic polymer binder selected from a group comprising a cellulose ester, a cellulose ether, and derivatives thereof, including:
providing the organic polymer binder in a concentration from 150 g/L to 550 g/L;
preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof;
preparing a volatile organic solvent; and
forming a first pre-mix by mixing the build material with the additive;
forming a second pre-mix by mixing the organic polymer binder with the volatile organic solvent;
mixing the first pre-mix and the second pre-mix to form a substantially homogeneous and flowable slurry mixture that is printed as a preliminary part of the said functionally graded article,
wherein the organic polymer binder is debound from the preliminary part in either or both a thermal decomposition treatment and a solvent debinding treatment followed by sintering to thereby produce a final part of the functionally graded article containing the build material having selectively varied in composition, structure including infill pattern or any combinations thereof gradually over volume of the final part thereof in one or more directions.

17. The method according to claim 16, wherein the method includes the step of forming two or more substantially homogeneous and flowable slurry mixtures, each comprising a respective first pre-mix and a respective second pre-mix.

18. The method according to claim 17, wherein the method includes the step of instantaneously mixing the two or more substantially homogeneous and flowable slurry mixtures in situ in a static or active mixer to form one substantially homogeneous and flowable slurry mixture.

19. The method according to claim 16, wherein the method includes the step of preparing a support material to form a substantially homogeneous and flowable support mixture configured for printing a support structure for an overhanging or cantilevered portion of the said functionally graded article.

20. A method of extrusion-based three-dimensional, 3D, printing a functionally graded article, characterised in that, the method comprising the steps:
providing a slurry feedstock, including:
preparing a build material comprising a metal, a ceramic or any combinations thereof, including:
providing the build material that is porous, non-porous or any combinations thereof; and
providing the build material in an amount from 10 vol. % to 90 vol. %;
preparing an organic polymer binder selected from a group comprising a cellulose ester, a cellulose ether, and derivatives thereof, including:
providing the organic polymer binder in a concentration from 150 g/L to 550 g/L;
preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
preparing a volatile organic solvent;
forming a first pre-mix by mixing the build material mixed with the additive;
forming a second pre-mix by mixing the organic polymer binder dissolved with the volatile organic solvent;
mixing the first pre-mix and the second pre-mix to form a substantially homogeneous and flowable slurry mixture that is printed as a preliminary part of the said functionally graded article;
debinding the organic polymer binder from the preliminary part in either or both a thermal decomposition treatment and a solvent debinding treatment; and
subjecting the preliminary part having the organic polymer binder debound therefrom to sintering for producing a final part of the functionally graded article containing the build material having selectively varied in composition, structure including infill pattern or any combinations thereof gradually over volume of the final part thereof in one or more directions.

21. The method according to claim 20, wherein the method includes the step of forming two or more substantially homogeneous and flowable slurry mixtures, each comprising a respective first pre-mix and a respective second pre-mix.

22. The method according to claim 22, wherein the method includes the step of instantaneously mixing the two or more substantially homogeneous and flowable slurry mixtures in situ in a static or active mixer to form one substantially homogeneous and flowable slurry mixture.

23. The method according to claim 20, wherein the method includes the step of providing a support structure for an overhanging or cantilevered portion of the said functionally graded article, wherein the support structure comprises a substantially homogeneous and flowable support mixture formed from a support material.

24. A system for extrusion-based three-dimensional, 3D, printing a functionally graded article, characterised in that, the system comprising:
one or more receptacles configured for receiving a slurry feedstock comprising:
a build material comprising a metal, a ceramic or any combinations thereof,
wherein the build material is porous, non-porous or any combinations thereof,
wherein the build material is in an amount from 10 vol. % to 90 vol. %;
an organic polymer binder selected from a group comprising a cellulose ester, a cellulose ether, and derivatives thereof,
wherein the organic polymer binder is in a concentration from 150 g/L to 550 g/L;
an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
a volatile organic solvent,
wherein the build material mixed with the additive and the organic polymer binder dissolved with the volatile organic solvent form a first pre-mix and a second pre-mix, respectively, that are mixed to form a substantially homogeneous and flowable slurry mixture;
a means for regulating injection of the slurry feedstock contained in the one or more receptacles thereof,
wherein the means for regulating injection is selected from a group comprising a solenoid valve, a mechanical pump and a combination thereof;
a computing unit comprising a control unit configured for generating a control signal to the said means for regulating injection,
wherein the control unit is connected to a database comprising a predefined set of material and rheology profiles employed to operatively effect the control signal in respect of a final part of the said functionally graded article;
a fluid drive device configured for providing a fluidic pressure to the slurry feedstock contained in the one or more receptacles thereof or to the means for regulating injection, which, in turn, actuates the slurry feedstock in the one or more receptacles connected thereof to provide a pressurized slurry feedstock,
wherein the fluid drive device is selected from a group comprising a pneumatic drive device, a hydraulic drive device, a mechanical displacement device and any combinations thereof; and
a print head operatively driven by the computing unit thereof configured for jetting the said substantially homogeneous and flowable slurry mixture to produce a preliminary part of the said functionally graded article,
wherein the organic polymer binder is debound from the preliminary part in either or both a thermal decomposition treatment and a solvent debinding treatment followed by sintering to thereby produce the final part of the functionally graded article containing the build material having selectively varied in composition, structure including infill pattern or any combinations thereof gradually over volume of the final part thereof in one or more directions.

25. The system according to claim 24, wherein the system comprises a static or active mixer configured for instantaneously mixing two or more substantially homogeneous and flowable slurry mixtures in situ to form one substantially homogeneous and flowable slurry mixture prior to transfer to the print head.

26. The system according to claims 24 and 25, wherein the one or more receptacles receives a support material forming a substantially homogeneous and flowable support mixture that prints, through the said print head or another print head, a support structure for an overhanging or cantilevered portion of the said functionally graded article.

27. A slurry feedstock for casting an article under a low pressure at a room temperature, characterised in that, the slurry feedstock comprising:
a build material comprising a metal, a ceramic or any combinations thereof,
wherein the build material is porous, non-porous or any combinations thereof,
wherein the build material is in an amount from 10 vol. % to 90 vol. %;
an organic polymer binder selected from a group comprising a cellulose ester, a cellulose ether, and derivatives thereof,
wherein the organic polymer binder is in a concentration from 50 g/L to 550 g/L;
an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
a volatile organic solvent,
wherein the build material mixed with the additive and the organic polymer binder dissolved with the volatile organic solvent form a first pre-mix and a second pre-mix, respectively, that are mixed to form a substantially homogeneous and flowable slurry mixture that is subjected to moulding in a cavity of a mould substantially immersed in a coagulation bath for producing a preliminary part of the said article by way of phase inversion,
wherein the organic polymer binder is debound from the preliminary part in either or both a thermal decomposition treatment and a solvent debinding treatment followed by sintering to thereby produce a final part of the article.

28. A method of preparing a slurry feedstock for casting an article under a low pressure at a room temperature, characterised in that, the method comprising the steps:
preparing a build material comprising a metal, a ceramic or any combinations thereof, including:
providing the build material that is porous, non-porous or any combinations thereof; and
providing the build material in an amount from 10 vol. % to 90 vol. %;
preparing an organic polymer binder selected from a group comprising a cellulose ester, a cellulose ether, and derivatives thereof, including:
providing the organic polymer binder in a concentration from 50 g/L to 550 g/L;
preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof;
preparing a volatile organic solvent; and
forming a first pre-mix by mixing the build material with the additive;
forming a second pre-mix by mixing the organic polymer binder with the volatile organic solvent;
mixing the first pre-mix and the second pre-mix to form a substantially homogeneous and flowable slurry mixture that is subjected to moulding in a cavity of a mould substantially immersed in a coagulation bath for producing a preliminary part of the said article by way of phase inversion;
wherein the organic polymer binder is debound from the preliminary part in either or both a thermal decomposition treatment and a solvent debinding treatment followed by sintering to thereby produce a final part of the article.

29. A method of casting an article under a low pressure at a room temperature, characterised in that, the method comprising the steps:
providing a slurry feedstock, including:
preparing a build material comprising a metal, a ceramic or any combinations thereof, including:
providing the build material that is porous, non-porous or any combinations thereof; and
providing the build material in an amount from 10 vol. % to 90 vol. %;
preparing an organic polymer binder selected from a group comprising a cellulose ester, a cellulose ether, and derivatives thereof, including:
providing the organic polymer binder in a concentration from 50 g/L to 550 g/L;
preparing an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
preparing a volatile organic solvent;
forming a first pre-mix by mixing the build material mixed with the additive;
forming a second pre-mix by mixing the organic polymer binder dissolved with the volatile organic solvent;
mixing the first pre-mix and the second pre-mix to form a substantially homogeneous and flowable slurry mixture;
subjecting the said substantially homogeneous and flowable slurry mixture to moulding in a mould;
substantially immersing the mould having a cavity filled with the substantially homogeneous and flowable slurry mixture thereof in a coagulation bath to produce a preliminary part of the said article by way of phase inversion;
debinding the organic polymer binder from the preliminary part in either or both a thermal decomposition treatment and a solvent debinding treatment; and
subjecting the preliminary part having the organic polymer binder debound therefrom to sintering for producing a final part of the article.

30. A system for casting an article under a low pressure at a room temperature, characterised in that, the system comprising:
one or more receptacles configured for receiving a slurry feedstock comprising:
a build material comprising a metal, a ceramic or any combinations thereof,
wherein the build material is porous, non-porous or any combinations thereof,
wherein the build material is in an amount from 10 vol. % to 90 vol. %;
an organic polymer binder selected from a group comprising a cellulose ester, a cellulose ether, and derivatives thereof,
wherein the organic polymer binder is in a concentration from 50 g/L to 550 g/L;
an additive selected from a group comprising a plasticizer, a defoaming agent, a dispersing agent, a sacrificial material, a fugitive material, a scaffolding material, a water-soluble inorganic salt, a foaming agent, a graphene, a graphene oxide, a flame retardant, a toner, a release additive, a stabilizer, an anti-static agent, an impact modifier, a colourant, an antioxidant and any combinations thereof; and
a volatile organic solvent,
wherein the build material mixed with the additive and the organic polymer binder dissolved with the volatile organic solvent form a first pre-mix and a second pre-mix, respectively, that are mixed to form a substantially homogeneous and flowable slurry mixture;
a mould configured for moulding the said substantially homogeneous and flowable slurry mixture received from the one or more receptacles thereof; and
a coagulation bath configured for substantially immersing the mould having a cavity filled with the substantially homogeneous and flowable slurry mixture therein to produce a preliminary part of the said article by way of phase inversion; and
a means for debinding the organic polymer binder from the preliminary part, wherein the means for debinding comprises either or both a thermal decomposition treatment and a solvent debinding treatment followed by sintering to thereby produce a final part of the article.

31. A feedstock composition for three-dimensional, 3D, printing, characterised in that, the feedstock comprising:
a build material; and
a binder solution,
wherein the binder solution is selected from the group consisting of cellulose ester, cellulose ether, and its derivatives,
wherein the composition is adapted into a slurry mixture form.

32. A three-dimensional, 3D, printed article, characterised in that, the 3D printed article comprising:
a build material; and
a binder solution,
wherein the binder solution is selected from the group consisting of cellulose ester, cellulose ether, and its derivatives,
wherein the composition is adapted into a slurry mixture form.

33. A method of preparing feedstock material for three-dimensional, 3D, printing, characterised in that, the method comprises steps:
preparing a binder solution selected from the group consisting of cellulose ester, cellulose ether, and its derivatives; and
mixing a build material and the binder to form a slurry mixture,
wherein the feedstock material can be directly pumped to a nozzle for printing.
